(19) United States
(12) Patent Application Publication
(10) Pub. No.: US 2014/0186585 A1
(43) Pub. Date: Jul. 3, 2014

(54) ABRASIVE BLASTING MEDIA AND METHODS OF FORMING AND USING SAME

(71) Applicant: Saint-Gobain Ceramics & Plastics, Inc., Worcester, MA (US)

(72) Inventors: Thomas G. Field, III, Lunenburg, MA (US); Anne-Laure Beaudonnet, Robion (FR); Samuel S. Marlin, Plan d'Orgon (FR)

(73) Assignee: Saint-Gobain Ceramics & Plastics, Inc., Worcester, MA (US)

(21) Appl. No.: 14/144,376

(22) Filed: Dec. 30, 2013

Related U.S. Application Data
(60) Provisional application No. 61/747,953, filed on Dec. 31, 2012.

(51) Int. Cl. B24C 11/00; C09K 3/14; B24C 1/00

(52) U.S. Cl. CPC B24C 11/00; B24C 1/00; C09K 3/1409
USPC 428/155; 451/38; 51/307

(57) ABSTRACT

Abrasive blasting media including a shaped abrasive particle and a method of preparing a surface of a workpiece including directing an abrasive matter at a workpiece, the abrasive matter includes a carrier and a plurality of shaped abrasive particles, and preparing a surface of the workpiece with the abrasive matter.

### CROSS-REFERENCE TO RELATED APPLICATION(S)

The present application claims priority from U.S. Provisional Patent Application No. 61/747,953, filed Dec. 31, 2012, entitled “ABRASIVE BLASTING MEDIA AND METHODS OF FORMING AND USING SAME,” naming inventors Thomas G. Field, III, Anne-Laure Beaudonnet, and Samuel S. Marlin, which application is incorporated by reference herein in its entirety.

### BACKGROUND

1. Field of the Disclosure

The following is directed to abrasive blasting media, and more particularly, abrasive blasting media including shaped abrasive particles.

2. Description of the Related Art

Abrasive articles are useful for various material removal operations including grinding, finishing, and polishing. Depending upon the type of abrasive material, abrasive particles can be useful in shaping or grinding a wide variety of materials and surfaces in the manufacturing of goods. Certain types of abrasive particles have been formulated to have particular geometries, such as triangular shaped abrasive particles and abrasive articles incorporating such objects. See, for example, U.S. Pat. Nos. 5,201,916; 5,366,523; and 5,984,988.

Three basic technologies that have been employed to produce abrasive particles having a specified shape are (1) fusion, (2) sintering, and (3) chemical ceramic. In the fusion process, abrasive particles can be shaped by a chill roll, the face of which may or may not be engraved, a mold into which molten material is poured, or a heat sink material immersed in an aluminum oxide melt. See, for example, U.S. Pat. No. 3,377,660, disclosing a process comprising the steps of flowing molten abrasive material from a furnace onto a cool rotating casting cylinder, rapidly solidifying the material to form a thin semisolid curved sheet, densifying the semisolid material with a pressure roll, and then partially fracturing the strip of semisolid material by reversing its curvature by pulling it away from the cylinder with a rapidly driven cooled conveyor.

In the sintering process, abrasive particles can be formed from refractory powders having a particle size of up to 10 micrometers in diameter. Binders can be added to the powders along with a lubricant and a suitable solvent, e.g., water. The resulting mixtures, mixtures, or slurries can be shaped into platelets or rods of various lengths and diameters. See, for example, U.S. Pat. No. 3,079,242, which discloses a method of making abrasive particles from calcined bauxite material comprising the steps of (1) reducing the material to a fine powder, (2) compacting under affirmative pressure and forming the fine particles of said powder into grain sized agglomerations, and (3) sintering the agglomerations of particles at a temperature below the fusion temperature of the bauxite to induce limited recrystallization of the particles, whereby abrasive grains are produced directly to size.

Chemical ceramic technology involves converting a colloidal dispersion or hydrosol (sometimes called a sol), optionally in a mixture, with solutions of other metal oxide precursors, to a gel or any other physical state that restrains the mobility of the components, drying, and firing to obtain a ceramic material. See, for example, U.S. Pat. Nos. 4,744,802 and 4,848,041.

Still, there remains a need in the industry for improving performance, life, and efficacy of abrasive particles, and the abrasive articles that employ abrasive particles.

### SUMMARY

According to one aspect, abrasive blasting media including a shaped abrasive particle is described herein. The shaped abrasive particle can have a body including a length (l), a width (w), and a height (hi), wherein the height (hi) is an interior height of the body, and wherein w>l and w>hi, moreover, the body can have a two-dimensional polygonal shape as viewed in a plane defined by a length and width, wherein the body comprises a shape selected from the group consisting of triangular, quadrilateral, rectangular, trapezoidal, pentagonal, hexagonal, heptagonal, hexagonal, octagonal, nonagonal, decagonal, pentagon, and a combination thereof. The body may comprises a two-dimensional shape as viewed in a plane defined by a length and a width of the body selected from the group consisting of ellipsoids, Greek alphabet characters, Latin alphabet characters, Russian alphabet characters, and a combination thereof.

In yet another aspect, a batch of blasting media configured to be projected at a workpiece for a surface treatment operation can include a first portion including a plurality of shaped abrasive particles. The batch may also include a second portion comprising a plurality of abrasive particles having a second particle characteristic, and wherein the second particle characteristic is different from the first particle characteristic by at least one particle characteristic selected from the group consisting of average particle size, average grain size, two-dimensional shape, composition, percent flashing, particle dimension, and a combination thereof.

According to another aspect, a method of preparing a surface of a workpiece includes directing an abrasive matter at a workpiece, the abrasive matter comprising a carrier and a plurality of shaped abrasive particles; and preparing a surface of the workpiece with the abrasive matter.

In yet another aspect, a method of preparing a surface of a workpiece includes directing an abrasive matter at a workpiece, the abrasive matter comprising a carrier and a plurality of shaped abrasive particles, increasing an average surface roughness (Ra) of a surface of the workpiece from an initial average surface roughness, and increasing an average wetting angle relative to an initial average wetting angle.

For one particular aspect, a workpiece having a surface modified by abrasive blasting media includes gouges randomly distributed across the surface, wherein the gouges have an average length and an average width, and further define an aspect ratio of average length:average width of at least about 2:1.

According to one aspect, an abrasive blasting media includes a shaped abrasive particle having a body including a length (l), a width (w), and a height (hi), wherein the height (hi) is an interior height of the body, and wherein w>l and w>hi, and further comprising a surviving grain factor of at least about 80%.

### BRIEF DESCRIPTION OF THE DRAWINGS

The present disclosure may be better understood, and its numerous features and advantages made apparent to those skilled in the art by referencing the accompanying drawings.

FIG. 1A includes an illustration of abrasive blasting media in accordance with an embodiment.

FIG. 1B includes a cross-sectional illustration of FIG. 1A according to an embodiment.

FIG. 2 includes a side view of a shaped abrasive particle according to an embodiment.

FIG. 3 includes an illustration of a surface preparation operation including abrasive matter directed at a workpiece according to an embodiment.

FIGS. 4-9 include illustrations of abrasive blasting media shaped abrasive particles according to embodiments.

FIG. 10a includes a picture of particular abrasive blasting media according to an embodiment.

FIG. 10b includes a picture of particular abrasive blasting media including shaped abrasive particles according to an embodiment.

FIG. 11 includes a picture of a surface modified by the abrasive blasting media of FIG. 10 according to an embodiment.

FIG. 12 includes a magnified image of a portion of FIG. 11.

FIGS. 13-15 include images of conventional abrasive blasting media.

FIG. 16 includes a plot demonstrating surviving grain factor for a sample representative of an embodiment and two conventional samples.

FIGS. 17 and 18 include images of a workpiece modified by conventional abrasive blasting media of FIGS. 13 and 15, respectively.

FIG. 19 includes a plot demonstrating surviving grain factor for a sample representative of an embodiment and two conventional samples.

FIG. 20 includes a side view image of a shaped abrasive particle according to an embodiment.

FIG. 21 includes a side view image of a shaped abrasive particle according to an embodiment.

FIG. 22 includes side view images of shaped abrasive particles according to an embodiment.

### DETAILED DESCRIPTION

The following is directed to abrasive blasting media, methods of forming abrasive blasting media, methods of using abrasive blasting media, methods of preparing workpieces using abrasive blasting media, and workpieces prepared by abrasive blasting media in accordance with an embodiment.

In accordance with one aspect, the abrasive blasting media can include a shaped abrasive particle. More particularly, the abrasive blasting media may include a shaped abrasive particle having a body that can have a predetermined shape in three dimensions. Shaped abrasive particles may differ from conventional crushed grains, which generally have an irregular and random shape. When considered as a batch, shaped abrasive particles may have one or more representative dimensional features that are substantially the same for at least a majority of the particles in the batch. A batch of conventional crushed grains generally does not exhibit one or more representative dimensional features that are substantially the same for at least a majority of particles in the batch. The one or more representative dimensional features may be, but not necessarily need be, linked to one or more conditions of forming, such that the one or more features may be substantially replicated from particle-to-particle.

Shaped abrasive particles of the abrasive blasting media may be obtained through various processing methods, including but not limited to, printing, molding, pressing, stamping, punching, casting, extruding, cutting, fracturing, heating, cooling, crystallizing, rolling, embossing, depositing, etching, scoring, and a combination thereof. According to one particular embodiment, the shaped abrasive particles can be formed via a screen printing process. The process may be initiated by forming a mixture including a ceramic material and a liquid. In particular, the mixture can be a gel formed of a ceramic powder material and a liquid, wherein the gel can be characterized as a shape-stable material having the ability to substantially hold a given shape even in the green (i.e., unfired) state. In accordance with an embodiment, the gel can be formed of the ceramic powder material as an integrated network of discrete particles. The mixture may contain a certain content of solid material, liquid material, and additives such that it has suitable rheological characteristics that form a dimensionally stable phase of material that can be formed through the process as described herein. Generally, a dimensionally stable phase of material is a material that can be formed to have a particular shape and substantially maintain the shape, such that the shape is substantially present in the finally-formed object.

The ceramic powder material can include an oxide, a nitride, a carbide, a boride, an oxycarbide, an oxynitride, and a combination thereof. In particular instances, the ceramic material can include alumina. The term “boehmite” is generally used herein to denote alumina hydrates including mineral boehmite, typically being Al₂O₃.H₂O and having a water content on the order of 15%, as well as pseudoboehmite, having a water content higher than 15%, such as 20-38% by weight. It is noted that boehmite (including pseudoboehmite) has a particular and identifiable crystal structure, and accordingly unique X-ray diffraction pattern, and as such, is distinguished from other aluminous materials including other hydrated aluminas such as ATH (aluminum trihydroxide) a common precursor material used herein for the fabrication of boehmite particulate materials.

The mixture can be formed to have a particular content of solid material, such as the ceramic powder material. For example, in one embodiment, the mixture can have a solids content of at least about 25 wt % and not greater than about 75 wt % for the total weight of the mixture. Furthermore, the mixture 101 can be formed to have a particular content of liquid material, including for example, a liquid content of at least about 25 wt % and not greater than about 75 wt % for the total weight of the mixture.

To facilitate suitable forming, the mixture may have a particular storage modulus, such as at least about 1×10⁴ Pa, at least about 4×10⁴ Pa, or even at least about 5×10⁴ Pa. However, in at least one non-limiting embodiment, the mixture may have a storage modulus of not greater than about 1×10⁷ Pa, such as not greater than about 2×10⁶ Pa. It will be appreciated that the storage modulus of the mixture can be within a range between any of the minimum and maximum values noted above. The storage modulus can be measured via a parallel plate system using ARES or AR-G2 rotational rheometers, with Peltier plate temperature control systems. For testing, the mixture can be extruded within a gap between two plates that are set to be approximately 8 mm apart from each other. After extruding the gel into the gap, the distance between the two plates defining the gap is reduced to 2 mm until the mixture completely fills the gap between the plates. After wiping away excess mixture, the gap is decreased by 0.1 mm and the test is initiated. The test is an oscillation strain sweep test conducted with instrument settings of a strain range between 01% to 100%, at 6.28 rad/s (1 Hz), using 25-mm parallel plate and recording 10 points per decade. Within 1 hour after the test completes, lower the gap again by 0.1 mm and repeat the test. The test can be repeated at least 6 times. The first test may differ from the second and third tests. Only the results from the second and third tests for each specimen should be reported.

Furthermore, the mixture can have a particular viscosity that facilitates processing. For example, the mixture can have a viscosity of at least about 4×10³ Pa s, at least about 8×10³ Pa s, at least about 20×10³ Pa s, at least about 40×10³ Pa s, or even at least about 65×10³ Pa s. In at least one non-limiting embodiment, the mixture may have a viscosity of not greater than about 100×10³ Pa s, not greater than about 95×10³ Pa s, or even not greater than about 85×10³ Pa s. It will be appreciated that the viscosity of the mixture can be within a range between any of the minimum and maximum values noted above. The viscosity can be measured in the same manner as the storage modulus as described above.

The mixture can be formed to have a particular content of organic materials, including for example, organic additives that can be distinct from the liquid, to facilitate processing and formation of shaped abrasive particles according to the embodiments herein. Some suitable organic additives can include stabilizers, UV curable resins, binders, such as fructose, sucrose, lactose, glucose, and the like.

Still, the content of organic materials within the mixture, particularly, any of the organic additives noted above, may be a minor amount as compared to other components within the mixture. In at least one embodiment, the mixture can be formed to have not greater than about 30 wt % organic material for the total weight of the mixture. Moreover, the mixture can be formed to have a particular content of acid or base distinct from the liquid, to facilitate processing and formation of shaped abrasive particles according to the embodiments herein. Some suitable acids or bases can include nitric acid, sulfuric acid, citric acid, chloric acid, tartaric acid, phosphoric acid, ammonium nitrate, and ammonium citrate.

Various systems may be used to shape the mixture and form precursor shaped abrasive particles. In one particular embodiment utilizing a screen printing operation, the mixture can be extruded through a die opening, and during extrusion within an application zone, a screen having a plurality of openings can travel under the die opening. In accordance with an embodiment, the openings can have a two-dimensional shape as viewed in a plane defined by the length (l) and width (w) of the screen that may include various shapes, including but not limited to, polygons, ellipsoids, numerals, Greek alphabet letters, Latin alphabet letters, Russian alphabet characters, complex shapes including a combination of polygonal shapes, and a combination thereof. In particular instances, the openings may have two-dimensional polygonal shapes such as, a triangle, a rectangle, a quadrilateral, a pentagon, a hexagon, a heptagon, an octagon, a nonagon, a decagon, and a combination thereof. The shape of the openings may facilitate substantial formation of one or more features of the shaped abrasive particles.

After forcing the mixture through the die opening and into the openings in the screen, precursor shaped abrasive particles may be printed on a belt disposed under the screen. During the process of extruding the mixture into the openings of the screen the belt may be in contact with the screen. Alternatively, the belt may be spaced apart from the screen. Notably, the mixture can be forced through the screen in rapid fashion, such that the average residence time of the mixture within the openings can be less than about 2 minutes, or even less than about 20 seconds. In particular non-limiting embodiments, the mixture may be substantially unaltered during printing as it travels through the screen openings, thus experiencing no change in the amount of components from the original mixture, and notably, may experience no appreciable drying in the openings of the screen.

The precursor shaped abrasive particles may be translated through a series of zones, wherein various treating processes may be conducted. Some suitable exemplary treating processes can include drying, heating, curing, reacting, radiating, mixing, stirring, agitating, planarizing, calcining, sintering, comminuting, sieving, doping, and a combination thereof. According to one embodiment, the precursor shaped abrasive particles may be translated through an optional shaping zone, wherein at least one exterior surface may be shaped as described in embodiments herein. Furthermore, the precursor shaped abrasive particles may be translated through an application zone, wherein one or more additives can be applied to the precursor shaped abrasive particles, which can be the same process of providing an additive to the raw material powder as described in embodiments herein. Within the application zone, the additive material may be applied utilizing various methods including for example, spraying, dipping, depositing, impregnating, transferring, punching, cutting, pressing, and any combination thereof. And further, the precursor shaped abrasive particles may be translated on the belt through a post-forming zone, wherein a variety of processes, including for example, drying, firing, and sintering may be conducted on the precursor shaped abrasive particles to form shaped abrasive particles.

In accordance with one embodiment, the shaped abrasive particle of the abrasive blasting media can have a particular shape. For example, the shaped abrasive particle can have a body including a length (l), a width (w), and a height (hi), where the height (hi) is an interior height of the body. The width can be greater than or equal to the length and the width can be greater than or equal to the height. It will be appreciated that the body of the shaped abrasive particle can generally have a two-dimensional polygonal shape, or a shape approximating a polygonal shape, as viewed in a plane defined by the length and width. More particularly, the body can have a two-dimensional shape as viewed in a plane define by the length and width having a polygonal shape, ellipsoidal shape, a numeral, a Greek alphabet character, Latin alphabet character, Russian alphabet character, complex shapes utilizing a combination of polygonal shapes and a combination thereof. Particular polygonal shapes include triangular, rectangular, quadrilateral, pentagon, hexagon, heptagon, octagon, nonagon, decagon, any combination thereof. Other irregular polygonal shapes may also be utilized, including for example, star-shaped particles, cross-shaped particles, truncated triangular-shaped particles, and the like.

In accordance with an embodiment, the body of the abrasive blasting media can include a polycrystalline material. Polycrystalline materials may include a plurality of abrasive grains, wherein each of the grains can define a crystalline grain and the individual grains are separated by grain boundaries. In particular instances, the abrasive grains can include materials such as nitrides, oxides, carbides, borides, oxycarbides, oxynitrides, oxyborides, diamond, and a combination thereof. In at least one particular instance, the abrasive grains can include an oxide material, more particularly, an oxide such as aluminum oxide, zirconium oxide, titanium oxide, yttrium oxide, chromium oxide, strontium oxide, silicon oxide, and a combination thereof. In one certain embodiment, the abrasive grains can include alumina, and more particularly, may consist essentially of alumina, such as alpha alumina.

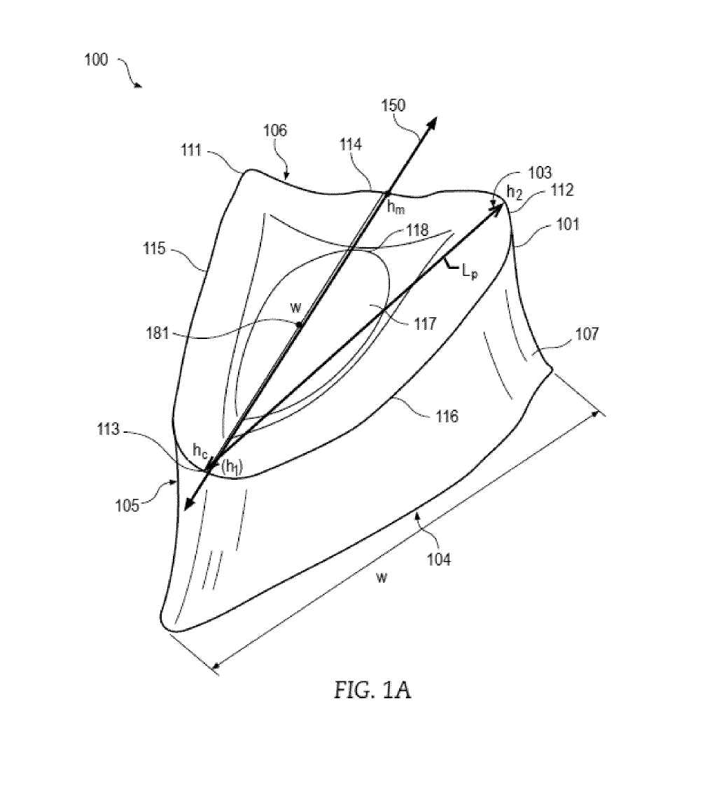

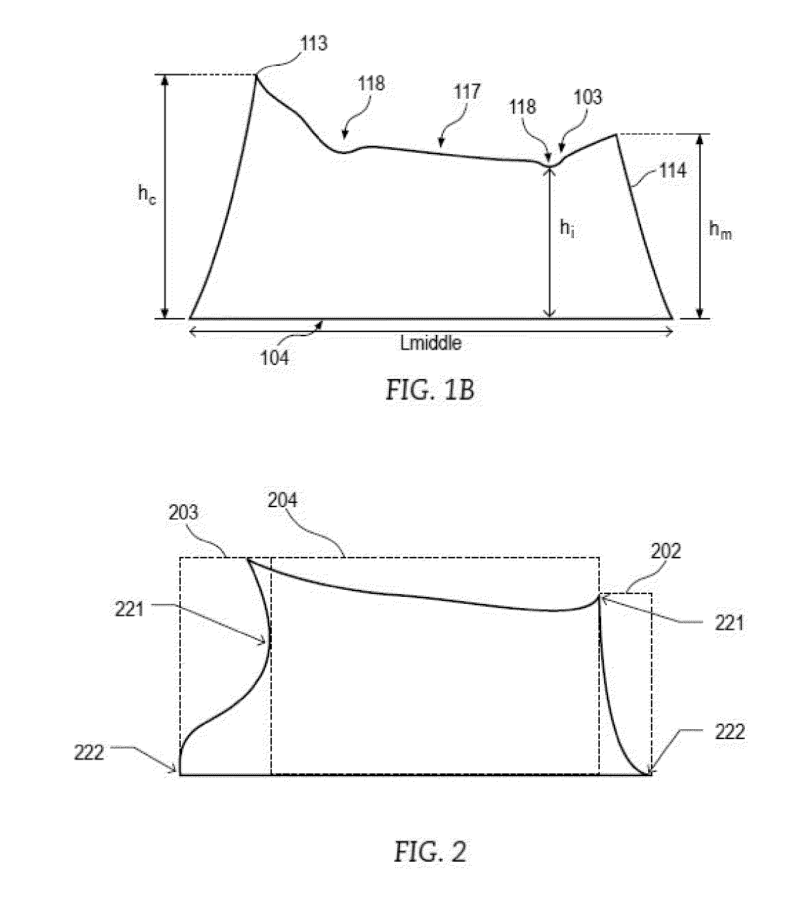

FIG. 1A includes an illustration of abrasive blasting media as a shaped abrasive particle in accordance with an embodiment. Additionally, FIG. 1B includes a cross-sectional illustration of FIG. 1A. The body 101 includes an upper surface 103 a bottom major surface 104 opposite the upper surface 103. The upper surface 103 and the bottom surface 104 can be separated from each other by side surfaces 105, 106, and 107. As illustrated, the body 101 of the shaped abrasive particle 100 can have a generally triangular shape as viewed in a plane of the upper surface 103. The body 101 can include a width (w) that can be the longest dimension of the body extending along a side, and can further include a height (h), which may be a dimension of the body 101 extending in a direction perpendicular to the length and width in a direction defined by a side surface of the body 101. Notably, as will be described in more detail herein, the body 101 can be defined by various heights depending upon the location. In specific instances, the width can be greater than or equal to the length, the length can be greater than or equal to the height, and the width can be greater than or equal to the height.

In particular, the body 101 can have a length (Lmiddle) as shown in FIG. 1B, which may be measured at the bottom surface 104 of the body 101 and extending from a corner 113 through a midpoint 181 of the body 101 to a midpoint at the opposite edge 114 of the body. Alternatively, the body can be defined by a second length or profile length (Lp), which can be a measure of the dimension of the body from a side view at the upper surface 103 from a first corner 113 to an adjacent corner 112. Notably, the dimension of Lmiddle can be a length defining a distance between a height at a corner (hc) and a height at a midpoint edge (hm) opposite the corner. The dimension Lp can be a profile length along a side of the particle defining the distance between h1 and h2. Reference herein to the length can be reference to either Lmiddle or Lp.

Moreover, reference herein to any dimensional characteristic (e.g., h1, h2, hi, w, Lmiddle, Lp, and the like) can be reference to a dimension of a single particle of a batch, a median value, or an average value derived from analysis of a suitable sampling of particles from a batch. Unless stated explicitly, reference herein to a dimensional characteristic can be considered reference to a median value that is a based on a statistically significant value derived from a sample size of suitable number of particles from a batch of particles. Notably, for certain embodiments herein, the sample size can include at least 40 randomly selected particles from a batch of particles. A batch of particles may be a group of particles that are collected from a single process run, and more particularly, may include an amount of shaped abrasive particles suitable for forming a commercial grade abrasive product, such as at least about 20 lbs. of particles.

In accordance with an embodiment, the body 101 can have a first corner height (hc) at a first region of the body defined by a corner 113. Notably, the corner 113 may represent the point of greatest height on the body 101, but the height at the corner 113 does not necessarily represent the point of greatest height on the body 101. The corner 113 can be defined as a point or region on the body 101 defined by the joining of the upper surface 103 and two side surfaces 105 and 107. The body 101 may further include other corners, spaced apart from each other, including for example, corner 111 and corner 112. As further illustrated, the body 101 can include edges 114, 115, and 116 that can separated from each other by the corners 111, 112, and 113. The edge 114 can be defined by an intersection of the upper surface 103 with the side surface 106. The edge 115 can be defined by an intersection of the upper surface 103 and side surface 105 between corners 111 and 113. The edge 116 can be defined by an intersection of the upper surface 103 and side surface 107 between corners 112 and 113.

As further illustrated, the body 101 can include a second midpoint height (hm) at a second end of the body, which can be defined by a region at the midpoint of the edge 114, which can be opposite the first end defined by the corner 113. The axis 150 can extend between the two ends of the body 101. FIG. 1B is a cross-sectional illustration of the body 101 along the axis 350, which can extend through a midpoint 181 of the body along the dimension of length (Lmiddle) between the corner 113 and the midpoint of the edge 114.

In accordance with an embodiment, the body 101 can have an average difference in height, which is a measure of the difference between hc and hm. For convention herein, average difference in height will be generally identified as hc−hm, however, it is defined an absolute value of the difference and it will be appreciated that average difference in height may be calculated as hm−hc when the height of the body 101 at the midpoint of the edge 114 is greater than the height at the corner 113. More particularly, the average difference in height can be calculated based upon a plurality of shaped abrasive particles from a suitable sample size, such as at least 40 particles from a batch as defined herein. The heights hc and hm of the particles can be measured using a STIL (Sciences et Techniques Industrielles de la Lumiere—France) Micro Measure 3D Surface Profilometer (white light (LED) chromatic aberration technique) and the average difference in height can be calculated based on the average values of hc and hm from the sample.

In one particular embodiment, the body 101 can have an average difference in height at different locations at the body. For example, the body 101 can have an average difference in height, which can be the absolute value of [hc−hm] between the first corner height (hc) and the second midpoint height (hm), of at least about 20 microns. It will be appreciated that average difference in height may be calculated as hm−hc when the height of the body 101 at a midpoint of the edge is greater than the height at an opposite corner. In other instances, the average difference in height [hc−hm], can be at least about 25 microns, at least about 30 microns, at least about 36 microns, at least about 40 microns, at least about 60 microns, such as at least about 65 microns, at least about 70 microns, at least about 75 microns, at least about 80 microns, at least about 90 microns, or even at least about 100 microns. In one non-limiting embodiment, the average difference in height can be not greater than about 300 microns, such as not greater than about 250 microns, not greater than about 220 microns, or even not greater than about 180 microns. It will be appreciated that the average difference in height can be within a range between any of the minimum and maximum values noted above.

Moreover, it will be appreciated that the average difference in height can be based upon an average value of hc. For example, the average height of the body 101 at the corners (Ahc) can be calculated by measuring the height of the body at all corners and averaging the values, and may be distinct from a single value of height at one corner (hc). Accordingly, the average difference in height may be given by the absolute value of the equation [Ahc−hi]. Furthermore, it will be appreciated that the average difference in height can be calculated using a median interior height (Mhi) calculated from a suitable sample size from a batch of shaped abrasive particles and an average height at the corners for all particles in the sample size. Accordingly, the average difference in height may be given by the absolute value of the calculation [Ahc−Mhi].

In particular instances, the body 101 can be formed to have a primary aspect ratio, which is a ratio expressed as width:length, having a value of at least 1:1. In other instances, the body 101 can be formed such that the primary aspect ratio (w:1) is at least about 1.5:1, such as at least about 2:1, at least about 4:1, or even at least about 5:1. Still, in other instances, the abrasive particle can be formed such that the body has a primary aspect ratio that is not greater than about 10:1, such as not greater than 9:1, not greater than about 8:1, or even not greater than about 5:1. It will be appreciated that the body 101 can have a primary aspect ratio within a range between any of the ratios noted above. Furthermore, it will be appreciated that reference herein to a height is the maximum height measurable of the abrasive particle. It will be described later that the abrasive particle may have different heights at different positions within the body 101 of the abrasive particle.

In addition to the primary aspect ratio, the body 101 can have a secondary aspect ratio, which can be defined as a ratio of length:height, wherein the height is an interior median height (Mhi). In certain instances, the secondary aspect ratio can be within a range between about 5:1 and about 1:3, such as between about 4:1 and about 1:2, or even between about 3:1 and about 1:2.

In accordance with another embodiment, the body 101 comprises a tertiary aspect ratio, defined by the ratio width:height, wherein the height is an interior median height (Mhi). The tertiary aspect ratio of the body 101 can be within a range between about 10:1 and about 1.5:1, such as between 8:1 and about 1.5:1, such as between about 6:1 and about 1.5:1, or even between about 4:1 and about 1.5:1.

According to one embodiment, the body 101 of the shaped abrasive particle can have particular dimensions, which may facilitate improved performance. For example, in one instance, the body 101 can have an interior height (hi), which can be the smallest dimension of height of the body 101 as measured along a dimension between any corner and opposite midpoint edge. In particular instances where the body 101 is a generally triangular two-dimensional shape, the interior height (hi) may be the smallest dimension of height (i.e., measure between the bottom surface 104 and the upper surface 105) for three measurements taken between each of the three corners and the opposite midpoint edges. The dimension of interior height (hi) of the body 101 is illustrated in FIG. 1B. According to one embodiment, the interior height (hi) can be at least about 22% of the width (w). The height (hi) of any particle may be measured by sectioning or mounting and grinding the shaped abrasive particle and viewing in a manner sufficient (e.g., light microscope or SEM) to determine the smallest height (hi) within the interior of the body 101. In one particular embodiment, the height (hi) can be at least about 25% of the width, such as at least about 28% of the width, at least about 29% of the width, such as at least about 30%, or even at least about 33% of the width of the body 101. For one non-limiting embodiment, the height (hi) of the body 101 can be not greater than about 80% of the width, such as not greater than about 76%, not greater than about 73%, not greater than about 70%, not greater than about 68%, not greater than about 56%, not greater than about 48%, or even not greater than about 40%. It will be appreciated that the height (hi) of the body 101 can be within a range between any of the above noted minimum and maximum percentages.

A batch of shaped abrasive particles, which can be at least a portion of a batch of abrasive blasting media, can have a controlled median interior height value (Mhi), which may facilitate improved performance. In particular, the median internal height (hi) of a batch can be related to a median width of the shaped abrasive particles of the batch in the same manner as described above. Notably, the median interior height (Mhi) can be at least about 22%, such as at least about 28%, at least about 29%, at least about 30%, or even at least about 33% of the median width of the shaped abrasive particles of the batch. For one non-limiting embodiment, the median interior height (Mhi) of the body can be not greater than about 80%, such as not greater than about 76%, not greater than about 73%, not greater than about 70%, not greater than about 68% of the width, not greater than about 56% of the width, not greater than about 48% of the width, or even not greater than about 40% of the median width. It will be appreciated that the median interior height (Mhi) of the body can be within a range between any of the above noted minimum and maximum percentages.

Furthermore, the batch of shaped abrasive particles, and thus at least a portion of the abrasive blasting media, may exhibit improved dimensional uniformity as measured by the standard deviation of a dimensional characteristic from a suitable sample size. According to one embodiment, the batch can have an interior height variation (Vhi), which can be calculated as the standard deviation of interior height (hi) for a suitable sample size of particles from a batch. According to one embodiment, the interior height variation can be not greater than about 60 microns, such as not greater than about 58 microns, not greater than about 56 microns, or even not greater than about 54 microns. In one non-limiting embodiment, the interior height variation (Vhi) can be at least about 2 microns. It will be appreciated that the interior height variation of the body can be within a range between any of the above noted minimum and maximum values.

For another embodiment, the body 101 can have an interior height (hi) of at least about 400 microns. More particularly, the height may be at least about 450 microns, such as at least about 475 microns, or even at least about 500 microns. In still one non-limiting embodiment, the height of the body 101 can be not greater than about 3 mm, such as not greater than about 2 mm, not greater than about 1.5 mm, not greater than about 1 mm, not greater than about 800 microns. It will be appreciated that the height of the body 101 can be within a range between any of the above noted minimum and maximum values. Moreover, it will be appreciated that the above range of values can be representative of a median interior height (Mhi) value for a batch of shaped abrasive particles.

Certain abrasive blasting media can include shaped abrasive particles having a body of a particular width (w). For example, the width can be at least about 600 microns, such as at least about 700 microns, at least about 800 microns, or even at least about 900 microns. In one non-limiting instance, the body 101 can have a width of not greater than about 4 mm, such as not greater than about 3 mm, not greater than about 2.5 mm, or even not greater than about 2 mm. It will be appreciated that the width of the body 101 can be within a range between any of the above noted minimum and maximum values. Moreover, it will be appreciated that the above range of values can be representative of a median width (Mw) for a batch of shaped abrasive particles.

In another aspect, the abrasive blasting media can include shaped abrasive particles having a body of a particular length (l). For example, the body can have a length (L middle or Lp) of at least about 0.4 mm, such as at least about 0.6 mm, at least about 0.8 mm, or even at least about 0.9 mm. Still, for at least one non-limiting embodiment, the body 101 can have a length of not greater than about 4 mm, such as not greater than about 3 mm, not greater than about 2.5 mm, or even not greater than about 2 mm. It will be appreciated that the length of the body 101 can be within a range between any of the above noted minimum and maximum values. Moreover, it will be appreciated that the above range of values can be representative of a median length (Ml), which may be more particularly, a median middle length (MLmiddle) or median profile length (MLp) for a batch of shaped abrasive particles, and thus, for at least a portion of a batch of abrasive blasting media including the shaped abrasive particles.

According to another embodiment, the abrasive blasting media can include a shaped abrasive particle having a body that may exhibit a particular amount of dishing, wherein the dishing value (d) can be defined as a ratio between an average height of the body at the corners (Ahc) as compared to smallest dimension of height of the body at the interior (hi). The average height of the body at the corners (Ahc) can be calculated by measuring the height of the body at all corners and averaging the values, and may be distinct from a single value of height at one corner (hc). The average height of the body at the corners or at the interior can be measured using a STIL (Sciences et Techniques Industrielles de la Lumiere—France) Micro Measure 3D Surface Profilometer (white light (LED) chromatic aberration technique). Alternatively, the dishing may be based upon a median height of the particles at the corner (Mhc) calculated from a suitable sampling of particles from a batch. Likewise, the interior height (hi) can be a median interior height (Mhi) derived from a suitable sampling of particles from a batch. According to one embodiment, the dishing value (d) can be not greater than about 2, such as not greater than about 1.9, not greater than about 1.8, not greater than about 1.7, not greater than about 1.6, not greater than about 1.5, not greater than about 1.25, not greater than about 1.2, not greater than about 1.15, or not greater than about 1.10. Still, in at least one non-limiting embodiment, the dishing value (d) can be at least about 0.9, such as at least about 1.0. It will be appreciated that the dishing ratio can be within a range between any of the minimum and maximum values noted above. Moreover, it will be appreciated that the above dishing values can be representative of a median dishing value (Md) for a batch of shaped abrasive particles, and thus, for at least a portion of a batch of abrasive blasting media including the shaped abrasive particles.

The body 101 can have a bottom surface 104 defining a bottom area (A_{b}). In particular instances, the bottom surface 104 can be the largest surface of the body 101. The bottom surface can have a surface area defined as the bottom area (A_{b}) that is greater than the surface area of the upper surface 103. Additionally, the body 101 can have a cross-sectional midpoint area (Aₘ) defining an area of a plane perpendicular to the bottom area and extending through a midpoint 181 of the particle. In certain instances, the body 101 can have an area ratio of bottom area to midpoint area (A_{b}/Aₘ) of not greater than about 6. In more particular instances, the area ratio can be not greater than about 5.5, such as not greater than about 5, not greater than about 4.5, not greater than about 4, not greater than about 3.5, or even not greater than about 3. Still, in one non-limiting embodiment, the area ratio may be at least about 1.1, such as at least about 1.3, or even at least about 1.8. It will be appreciated that the area ratio can be within a range between any of the minimum and maximum values noted above. Moreover, it will be appreciated that the above area ratios can be representative of a median area ratio for a batch of shaped abrasive particles, and thus, for at least a portion of a batch of abrasive blasting media including the shaped abrasive particles.

Furthermore, the abrasive blasting media incorporating shaped abrasive particles of the embodiments herein, including for example, the particle of FIG. 1B can have a normalized height difference of not greater than about 0.3. The normalized height difference can be defined by the absolute value of the equation [(hc−hm)/(hi)]. In other embodiments, the normalized height difference can be not greater than about 0.26, such as not greater than about 0.22, or even not greater than about 0.19. Still, in one particular embodiment, the normalized height difference can be at least about 0.04, such as at least about 0.05, or even at least about 0.06. It will be appreciated that the normalized height difference can be within a range between any of the minimum and maximum values noted above. Moreover, it will be appreciated that the above normalized height values can be representative of a median normalized height value for a batch of shaped abrasive particles, and thus, for at least a portion of a batch of abrasive blasting media including the shaped abrasive particles.

In another instance, the body can have a profile ratio of at least about 0.04, wherein the profile ratio is defined as a ratio of the average difference in height [hc−hm] to the length (Lmiddle) of the shaped abrasive particle, defined as the absolute value of [(hc−hm)/(Lmiddle)]. It will be appreciated that the length (Lmiddle) of the body can be the distance across the body 101 as illustrated in FIG. 1B. Moreover, the length may be an average or median length calculated from a suitable sampling of particles from a batch of shaped abrasive particles. According to a particular embodiment, the profile ratio can be at least about 0.05, at least about 0.06, at least about 0.07, at least about 0.08, or even at least about 0.09. Still, in one non-limiting embodiment, the profile ratio can be not greater than about 0.3, such as not greater than about 0.2, not greater than about 0.18, not greater than about 0.16, or even not greater than about 0.14. It will be appreciated that the profile ratio can be within a range between any of the minimum and maximum values noted above. Moreover, it will be appreciated that the above profile ratio can be representative of a median profile ratio for a batch of shaped abrasive particles.

According to another embodiment, the body can have a particular rake angle, which may be defined as an angle between the bottom surface 104 and a side surface 105, 106 or 107 of the body. For example, the rake angle may be within a range between about 1° and about 80°. For other particles herein, the rake angle can be within a range between about 5° and 55°, such as between about 10° and about 50°, between about 15° and 50°, or even between about 20° and 50°. Formation of an abrasive particle having such a rake angle may improve the performance of the abrasive blasting media.

According to another embodiment, the abrasive blasting media particle of FIGS. 1A and 1B can have an ellipsoidal region 117 in the upper surface 103 of the body 101. The ellipsoidal region 117 can be defined by a trench region 118 that can extend around the upper surface 103 and define the ellipsoidal region 117. The ellipsoidal region 117 can encompass the midpoint 181. Moreover, it is thought that the ellipsoidal region 117 defined in the upper surface can be an artifact of the forming process, and may be formed as a result of the stresses imposed on the mixture during forming.

In one aspect, the body 101 can have a percent flashing that may facilitate improved performance. Notably, the flashing can be defined by an area of the particle as viewed along one side, such as illustrated in FIG. 2, wherein the flashing can extend from a side surface of the body within the boxes 202 and 203. The flashing can represent tapered regions proximate to the upper surface and bottom surface of the body. For example, the side surfaces of the particles can be tapered relative to a vertical axis extending in the direction of the height of the body. The flashing can be measured as the percentage of area of the body along the side surface contained within a box extending between an innermost point of the side surface (e.g., 221) and an outermost point (e.g., 222) on the side surface of the body. In one particular instance, the body can have a particular content of flashing, which can be the percentage of area of the body contained within the boxes 202 and 203 compared to the total area of the body contained within boxes 202, 203, and 204. According to one embodiment, the percent flashing (f) of the body can be at least about 10%. In another embodiment, the percent flashing can be greater, such as at least about 12%, such as at least about 14%, at least about 16%, at least about 18%, or even at least about 20%. Still, in a non-limiting embodiment, the percent flashing of the body can be not greater than about 45%, such as not greater than about 40%, or even not greater than about 36%. It will be appreciated that the percent flashing of the body can be within a range between any of the above minimum and maximum percentages. Moreover, it will be appreciated that the above flashing percentages can be representative of an average flashing percentage or a median flashing percentage for a batch of shaped abrasive particles, and thus, for at least a portion of a batch of abrasive blasting media including the shaped abrasive particles.

The percent flashing can be measured by mounting the particle on its side and viewing the body to generate a black and white image, such as illustrated in FIG. 2. A suitable program for conducting such measurements includes ImageJ software. The percentage flashing can be calculated by determining the area of the body 201 in the boxes 202 and 203 compared to the total area of the body as viewed at the side (total shaded area), including the area in the center 204 and within the boxes. Such a procedure can be completed for a suitable sampling of particles to generate average, median, and/or and standard deviation values.

A batch of abrasive blasting media shaped abrasive particles according to embodiments herein may exhibit improved dimensional uniformity as measured by the standard deviation of a dimensional characteristic from a suitable sample size of particles from the batch. According to one embodiment, the batch of shaped abrasive particles can have a flashing variation (Vf), which can be calculated as the standard deviation of flashing percentage (f) for a suitable sample size of particles from a batch. According to one embodiment, the flashing variation can be not greater than about 5.5%, such as, not greater than about 5.3%, not greater than about 5%, or not greater than about 4.8%, not greater than about 4.6%, or even not greater than about 4.4%. In one non-limiting embodiment, the flashing variation (Vf) can be at least about 0.1%. It will be appreciated that the flashing variation can be within a range between any of the minimum and maximum percentages noted above.

The abrasive blasting media shaped abrasive particles of the embodiments herein can have a height (hi) and flashing multiplier value (hiF) of at least 4000, wherein hiF=(hi)(f), an “hi” represents a minimum interior height of the body as described above and “f” represents the percent flashing. In one particular instance, the height and flashing multiplier value (hiF) of the body can be greater, such as at least about 4500 micron %, at least about 5000 micron %, at least about 6000 micron %, at least about 7000 micron %, or even at least about 8000 micron %. Still, in one non-limiting embodiment, the height and flashing multiplier value can be not greater than about 45000 micron %, such as not greater than about 30000 micron %, not greater than about 25000 micron %, not greater than about 20000 micron %, or even not greater than about 18000 micron %. It will be appreciated that the height and flashing multiplier value of the body can be within a range between any of the above minimum and maximum values. Moreover, it will be appreciated that the above multiplier value can be representative of a median multiplier value (MhiF) for a batch of shaped abrasive particles, and thus, for at least a portion of a batch of abrasive blasting media including the shaped abrasive particles.

Certain shaped abrasive particles of the embodiments herein can have a dishing (d) and flashing (F) multiplier value (dF) as calculated by the equation dF=(d)(F), wherein dF is not greater than about 90%, and “d” represents the dishing value, and “f” represents the percentage flashing of the body. In one particular instance, the dishing (d) and flashing (F) multiplier value (dF) of the body can be not greater than about 70%, such as not greater than about 60%, not greater than about 55%, not greater than about 48%, not greater than about 46%. Still, in one non-limiting embodiment, the dishing (d) and flashing (F) multiplier value (dF) can be at least about 10%, such as at least about 15%, at least about 20%, at least about 22%, at least about 24%, or even at least about 26%. It will be appreciated that the dishing (d) and flashing (F) multiplier value (dF) of the body can be within a range between any of the above minimum and maximum values. Moreover, it will be appreciated that the above multiplier value can be representative of a median multiplier value (MdF) for a batch of shaped abrasive particles and thus, for at least a portion of a batch of abrasive blasting media including the shaped abrasive particles.

According to another embodiment, the body can have a height and dishing ratio (hi/d) as calculated by the equation hi/d=(hi)/(d), wherein hi/d is not greater than about 1000, “hi” represents a minimum interior height as described above, and “d” represents the dishing of the body. In one particular instance, the ratio (hi/d) of the body can be not greater than about 900 microns, not greater than about 800 microns, not greater than about 700 microns, or even not greater than about 650 microns. Still, in one non-limiting embodiment, the ratio (hi/d), can be at least about 10 microns, such as at least about 50 microns, at least about 100 microns, at least about 150 microns, at least about 200 microns, at least about 250 microns, or even at least about 275 microns. It will be appreciated that the ratio (hi/d) of the body can be within a range between any of the above minimum and maximum values. Moreover, it will be appreciated that the above height and dishing ratio can be representative of a median height and dishing ratio (Mhi/d) for a batch of shaped abrasive particles, and thus, for at least a portion of a batch of abrasive blasting media including the shaped abrasive particles.

The body of the abrasive blasting media may be formed entirely of a polycrystalline material. That is, in certain instances the body can be essentially free of a binder. Moreover, in other instances, the body may be essentially free of any organic materials, and more particularly, the body can consist essentially of at least one inorganic material.

In another embodiment, the body may be a composite material, and may include at least two different types of abrasive grains For example, the body can include a first layer and a second layer overlying the first layer, wherein the first layer includes a first composition and the second layer includes a second composition that is distinct from the first composition. The first composition and the second composition may be different from each other by at least one element. Alternatively or additionally, the first composition and second composition can be different from each other by at least one weight percent of a particular element present within the composition. More particularly, the difference between the first composition and the second composition can be at least about 2 wt %, such as at least about 4 wt %, at least about 8 wt %, at least about 10 wt %, at least about 15 wt %, or even at least about 20 wt % of at least one element present within the first composition and the second composition.

In an alternative embodiment, the body can include a composite, wherein the body includes a first region and a second region distinct from the first region. Notably, in certain instances, the first region can be in compression and the second region can be in tension. In certain instances, facilitation of a difference in compression and tension between the first region and second region may be accomplished by utilization of a first region including a first composition and a second region including a second composition that is distinct from the first composition. In other instances, it will be appreciated that the first region and second region may be arranged within the body of the shaped abrasive particle and a variety of manners. For example, in one instance, the first region can be present within a central region of the body surrounding a midpoint, while the second region surrounds the first region and exists at a peripheral region of the body. Alternatively, the first region may exist at a peripheral region and the second region may exist at a central region. In yet another embodiment, the first region and second region may be arranged relative to each other in the form of layers, wherein a first region is in the form of a first layer and the second region is in the form of a second layer overlying the first region. Moreover, it will be appreciated, that the body can include a composite that includes more than a first and a second region, including for example, a third region, fourth region, fifth region and the like.

In accordance with an embodiment, the abrasive blasting media can include a surviving grain factor of at least about 80% when subject to a particular surface preparation operation according to an embodiment. In certain embodiments, the surviving grain factor of the abrasive blasting media herein can be greater, such as at least about 82%, at least about 84%, at least about 86%, at least about 88%, or even at least about 90%. Still, the abrasive blasting media may have a surviving grain factor of not greater than 99.5%. It will be appreciated, that the abrasive blasting media may have a surviving grain factor within a range between any of the minimum and maximum percentages noted above.

The surface preparation operation used to characterize the surviving grain factor is configured to be conducted according to standardized conditions, including weighing and providing an initial test batch of 100 grams of the abrasive blasting media. Directing the batch of abrasive blasting media at a workpiece of steel (e.g., 304L stainless steel) using a pressure of 1 bar and a blasting nozzle having an opening of 8 mm in diameter at room temperature. The blasting nozzle is spaced apart from the surface of the workpiece by 15 cm. The axis of the blasting nozzle defining the internal axis of the bore and primary direction of the abrasive blasting media is affixed at a perpendicular angle relative to the surface of the workpiece. One cycle is completed when the entire batch of abrasive blasting media is ejected from blasting nozzle at the workpiece without recycling. After each cycle, the abrasive blasting media is recovered and sieved. The recovered particles are reloaded into the blasting machine and utilized in another cycle of the blasting operation according to the conditions above. Twenty (20) cycles are completed and the particles are recovered and sieved before reloading the blasting machine. The sieving process is configured to remove particles that are less than 60% of the initial average particles size of the initial test batch of 100 grams. The surviving grain factor is calculated by the weight of the batch after 20 cycles and a final 20^{th} sieving cycle as compared to the weight of the initial test batch (100 grams).

In another aspect, the abrasive blasting media can be part of a batch of blasting media. The batch can include a first portion that may include shaped abrasive particles as described by embodiments herein. Furthermore, the batch may include a second portion that includes a second abrasive particle that is different than the shaped abrasive particle by at least one particle characteristic including for example abrasive particle size, (i.e., average size of crystalline grains within the particle), hardness, toughness, friability, density, porosity, color, loose packed density (LPD), and any combination thereof. For example, the second portion can include a plurality of randomly-shaped abrasive particles. Such randomly shaped abrasive particles may be utilized or obtained through conventional techniques, including, but not limited to, sieving, crushing, and a combination thereof. In one particular instance, the second portion can include diluent abrasive grains which may not only vary in shape relative to the shaped abrasive particles of the first portion, but may further be distinct from the shaped abrasive particles by composition, average particle size, average grain size (i.e., average size of crystalline grains within the particle), hardness, toughness, friability, density, porosity, color, loose packed density (LPD), and a combination thereof.

In accordance with one particular embodiment, the first portion can be present in a particular amount (W1) which may be a measure of weight percent of the first portion for a total weight of the batch of the blasting media. Furthermore, the batch can include a particular content of the second portion (W2) that may be present in an amount (weight percent) for a total weight of the batch of blasting media. More particularly, the batch can include particular ratios of the amount of the first portion relative to the amount of the second portion. For example, W1 and W2 can be different from each other. In one instance, W1 can be greater than W2. In yet another embodiment, W2 may be greater than W1. Alternatively, W1 and W2 can be substantially the same.

According to one embodiment, the batch can include a ratio (W1/W2) that can be at least about 0.1. In other embodiments, the ratio (W1/W2) can be greater, such as at least about 0.3, such as at least about 0.7, at least about 1, at least about 3, at least about 5, or even at least about 10. Still, the ratio (W1/W2) may be limited, such that it is not greater than about 100, not greater than about 95, not greater than about 90, not greater than about 85, or even not greater than about 80. It will be appreciated that the batch can include a ratio (W1/W2) that can be within a range between any of the values noted above.

Still, in other embodiments, the batch may utilize a first portion including shaped abrasive particles and a second portion that includes shaped abrasive particles. It will be appreciated that the shaped abrasive particles of the second portion may be distinct from the shaped abrasive particles of the first portion by at least one particle characteristic, including for example, two-dimensional shape, particle size, average grain size, and any of the features associated with the shaped abrasive particles of the embodiments herein. In particular instances, a plurality of shaped abrasive particles of the first portion can have a different average particle size compared to the average particle size of the abrasive particles of the second portion. For example, the shaped abrasive particles of the first portion can have a greater average particle size as compared to the average particle size of the abrasive particles of the second portion. Still, in other embodiments, the abrasive particles of the second portion can have a greater average particles size as compared to the shaped abrasive particles of the first portion.

In accordance with a particular embodiment, the body of the abrasive blasting media can include multiple phases of materials, including in particular, a first phase, and a second phase having a composition distinct from the first phase. For example, the body can include a first phase that includes at least about 70 wt % alumina for a total weight of the first phase. Additionally, the body can include at least 0.1 wt % of the second phase for the total weight of the body.

In accordance with an embodiment, the body can be formed to have a particular distribution of the second phase within the volume of the body. For example, second phase may be an integral phase within the body. Moreover, the second phase may be substantially uniformly dispersed through the entire volume of the body. Alternatively, the second phase may be non-uniformly dispersed within the body. For example, in one embodiment, the body can have a different content of the second phase at a peripheral region of the body as compared to the content of the second phase at a central region of the body.

The second phase can be disposed within domains or between domains of any of the other phases present within the body. A domain can include a single crystal or a group of crystals having the same or substantially the same alignment when viewed in two dimensions. In one embodiment, the second phase may be disposed at the grain boundaries of any of the other phases, and more particularly, a majority of the second phase may be disposed as an intergranular phase (i.e., between grains at the grain boundaries) between any of the phases described in embodiments herein. For example, at least 60% of the total content of the second phase can be disposed at the grain boundaries of the first phase. In other embodiments, the amount of second phase disposed at the grain boundaries can be greater, such as at least about 70% of the second phase, at least about 80% of the second phase, at least about 90% of the second phase, or even in some instances essentially all of the second phase can be disposed at the grain boundary of the first phase.

The first phase may have a certain content of alumina, such as at least about 70 wt % alumina for a total weight of the first phase. For other embodiments, the body can include at least about 71 wt % alumina for the total weight of the first phase, such as least about 75 wt %, at least about 77 wt %, at least about 80 wt %, at least about 83 wt %, at least about 85 wt %, at least about 88 wt %, at least about 90 wt %, at least about 93 wt %, at least about 95 wt %, or even consist essentially of alumina.

Furthermore, the particulate material can have a body including at least about 70 wt % of the first phase for the total weight of the body. In other instances, the total content of the first phase may be greater, such as at least about 75 wt %, at least about 77 wt %, at least about 80 wt %, at least about 83 wt %, at least about 85 wt %, at least about 88 wt %, at least about 90 wt %, at least about 93 wt % or even at least about 95 wt % for the total weight of the body. Still, the body may include not greater than about 99.5 wt %, not greater than about 99 wt %, or even not greater than about 98 wt % of the first phase for the total weight of the body. It will be appreciated that the total content of the first phase within the body can be within a range between any of the minimum and maximum percentages noted above.

In accordance with one particular embodiment, the second phase can include phosphate, and more particularly may include a majority content of phosphate in at least one rare earth element. In one particular instance, the second phase can consist essentially of phosphate and at least one rare earth element, and more particularly can consist essentially of monazite (LaPO₄). Furthermore, the second phase may include a crystalline material more particularly may consist essentially of a crystalline material. In other instances, the second phase can include a monoclinic crystalline structure, and more particularly, may consist essentially of a monoclinic crystalline structure.

Moreover, the body can include at least 0.1 wt % of the second phase for the total weight of the body. For other embodiments, the content of the second phase within the body can be greater, such as at least about 0.2 wt %, at least about 0.3 wt %, at least about 0.5 wt %, at least about 0.6 wt %, at least about 0.7 wt %, at least about 0.9 wt %, at least about 1.0 wt %, or even at least about 1.1 wt %. Still, the content of the second phase within the body may be limited, such that it may be not greater than about 30 wt %, such as not greater than about 20 wt %, not greater than about 15 wt %, not greater than about 13 wt %, not greater than about 12 wt %, not greater than about 10 wt %, not greater than about 9 wt %, not greater than about 8 wt %, not greater than about 7 wt %, not greater than about 6 wt %, not greater than about 5 wt %, not greater than about 4 wt %, not greater than about 3 wt %, or even not greater than about 2 wt %. It will be appreciated that the content of the second phase within the body can be within a range between any of the minimum and maximum percentages noted above.

In another embodiment, the body of the abrasive blasting media can include a ratio of the first and second phases defined by (WP1/WP2), wherein WP1 represents the weight percent of the first phase for the total weight of the body and WP2 represents the weight percent of the second phase for the total weight of the body. In at least one aspect, the ratio (WP1/WP2), can be at least about 1, such as at least about 1.1, at least about 1.5, at least about 2, at least about 3, at least about 5, at least about 8, at least about 10, at least about 15, at least about 20, at least about 50, or even at least about 70. Still, in another embodiment, the ratio (WP1/WP2) can be not greater than about 100, or even not greater than about 95. It will be appreciated that the body can have a ratio (WP1/WP2) within a range between any of the minimum and maximum values provided above.

In yet another embodiment, the body can be an alumina-based body such that it contains a majority content of alumina crystals and a minority content of a primary additive composition within the body, wherein the primary additive composition can be distinct from the alumina. In one particular instance, the primary additive composition can include a combination of magnesium and calcium. More particularly, the magnesium calcium may be present within a particular additive ratio (Mg:Ca). For example, the additive ratio can be within a range between about 1:1 and about 10:1.

In reference to the body including a primary additive composition, the body may include a minimum amount of calcium. For example, the body may include at least about 0.2 wt % calcium for the total weight of the body. It will be appreciated that the content of calcium may be present in the form of an oxide compound, including for example calcium oxide. Moreover, it will be appreciated that the content of magnesium may be present within a compound form, such as an oxide compound form, including for example magnesium oxide.

The body including alumina and the primary additive composition may further include a particular amount of magnesium. For example, the amount of magnesium may be not greater than about 5 wt %, such as not greater than about 4 wt %, or even not greater than about 3 wt %. Still, it will be appreciated that the body can include a minimum amount of magnesium, such as at least about 0.1 wt %, at least about 0.2 wt %, at least about 0.4 wt %, or even at least about 1.0 wt % for the total weight of the body. It will be appreciated that the content of magnesium within the body can be within range between any of the above minimum and maximum percentages.

In further reference to a body incorporating alumina and a primary additive composition, the body may consist essentially of the alumina crystals and the primary additive composition. Moreover, a majority of the primary additive composition may be preferentially located at crystal boundaries of the alumina crystals. For example, the additive including the calcium may be preferentially located at the crystal boundaries of the alumina. Furthermore, the magnesium within the primary additive composition may be substantially, uniformly dispersed throughout the body within the crystals and at the crystal boundaries. It will be appreciated, that the primary additive composition may consist essentially of magnesium and calcium.

Moreover, certain abrasive blasting media according to embodiments herein can be essentially free of certain materials, including but not limited to, alkali metal elements, alkaline metal elements, sodium, yttrium, manganese, and even iron.

The batch may be contained within particular packaging for sale and shipment to consumers. For example, the batch may be contained within a sealed package, such as a bag or drum. Furthermore, the batch may be provided with instructions for use. Specific aspects of the instructions may be incorporated within the sealed package. Exemplary content of the instructions may include directions for use, including for example, mixing instructions for combining the abrasive blasting media with other abrasive particles, such as, randomly-shaped abrasive particles. Such mixes may be suitable for achieving different surface finishes of a particular workpiece. Additionally, the instructions may further include recommendations for conditions of use. The batch may be provided with a material safety data sheet (MSDS), providing handling instructions and safety information for the use of the particles by a customer.

It will be appreciated that the batch of abrasive blasting media can be configured to be projected at a workpiece for a surface preparation operation. Surface preparation operations can include removing material from at least a portion of the surface of the workpiece, cleaning at least a portion of the surface of the workpiece, or plastically deforming a portion of the surface of the workpiece. Workpieces suitable for use with the abrasive blasting media can include metals, metal alloys, glasses, ceramics, organic material, polymer, resins, epoxies, and a combination thereof. In particular instances, the workpiece may include a metal alloy, more particularly, an iron-based alloy, such as steel. In accordance with one particular embodiment, the workpiece can comprise stainless steel.

In one aspect, the batch of abrasive blasting media may be utilized to conduct a surface preparation operation on a workpiece by first directing abrasive matter at the workpiece, and as a result, preparing the surface of the workpiece by altering at least a portion of the surface of the workpiece. Reference herein to abrasive matter can include the abrasive blasting media and a carrier. The carrier may be utilized to deliver the abrasive blasting media to the workpiece. In particular, the process of directing the abrasive matter can include projecting shaped abrasive particles of the batch of abrasive blasting media at a workpiece as free abrasive particles in a stream. In certain instances, the carrier can include a gaseous material, including for example, air. In particular instances, the carrier may consist essentially of air. Alternatively, the carrier can include other gaseous materials, including for example inert gases, nitrogen, oxygen, and other readily available gaseous materials. In an alternative embodiment, the carrier may include at least one liquid phase component.

Prior to utilizing the shaped abrasive particles as abrasive blasting media it may be appropriate to conduct a gathering operation, which may include a sorting operation to sort the abrasive blasting media according to certain desired particle characteristics. Particles for use in the abrasives industry are generally graded to a given particle size distribution before use. Such distributions typically have a range of particle sizes, from coarse particles to fine particles. In the abrasive art this range is sometimes referred to as a “coarse”, “control”, and “fine” fractions. Abrasive particles graded according to abrasive industry accepted grading standards specify the particle size distribution for each nominal grade within numerical limits. Such industry accepted grading standards (i.e., abrasive industry specified nominal grade) include those known as the American National Standards Institute, Inc. (ANSI) standards, Federation of European Producers of Abrasive Products (FEPA) standards, and Japanese Industrial Standard (JIS) standards.

ANSI grade designations (i.e., specified nominal grades) include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. FEPA grade designations include P8, P12, P16, P24, P36, P40, P50, P60, P80, P100, P120, P150, P180, P220, P320, P400, P500, P600, P800, P1000, and P1200. JIS grade designations include JIS8, JIS12, JIS 16, JIS24, JIS36, JIS46, JIS54, JIS60, JIS80, JIS 100, JIS150, JIS180, JIS220, JIS240, JIS280, JIS320, JIS360, JIS400, JIS600, JIS800, JIS 1000, JIS 1500, JIS2500, JIS4000, JIS6000, JIS8000, and JIS10,000. Alternatively, the shaped abrasive particles 20 can graded to a nominal screened grade using U.S.A. Standard Test Sieves conforming to ASTM E-1 1 “Standard Specification for Wire Cloth and Sieves for Testing Purposes.” ASTM E-1 1 prescribes the requirements for the design and construction of testing sieves using a medium of woven wire cloth mounted in a frame for the classification of materials according to a designated particle size. A typical designation may be represented as −18+20 meaning that the particles pass through a test sieve meeting ASTM E−1 1 specifications for the number 18 sieve and are retained on a test sieve meeting ASTM E−1 1 specifications for the number 20 sieve. In various embodiments, the particulate material can have a nominal screened grade comprising: −18+20, −20+25, −25+30, −30+35, −35+40, −40+45, −45+50, −50+60, −60+70, −70+80, −80+100, −100+120, −120+140, −140+170, −170+200, −200+230, −230+270, −270+325, −325+400, −400+450, −450+500, or −500+635. Alternatively, a custom mesh size could be used such as −90+100. The body of the particulate material may be in the form of a shaped abrasive particle, as described in more detail herein.

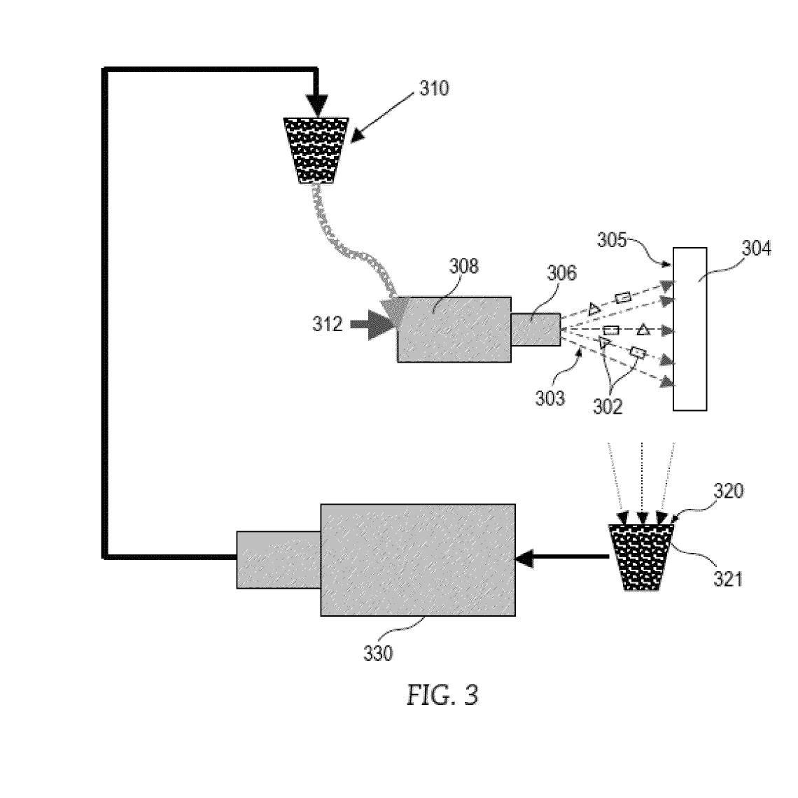

FIG. 3 includes an illustration of a surface preparation operation according to an embodiment. As illustrated, abrasive matter 301 can include abrasive blasting media comprising shaped abrasive particles 302 that is directed toward a surface 305 of a workpiece 304 via a carrier 303. In particular, as illustrated, the abrasive matter 301 can be ejected from a nozzle 306, which can be connected to a blasting machine 308 that may provide controlled operating parameters (e.g., size of nozzle, pressure, temperature, etc.) for the surface preparation operation.

In certain instances, the process of preparing a surface can include directing the abrasive matter 301 at the workpiece 304 in a manner, wherein the velocity of the abrasive matter 301 is controlled. The velocity of the abrasive matter 301 may be selected by utilizing a particular pressure of the carrier, via an input 312, to control the rate at which the abrasive blasting media 302 is expelled from a blasting machine at the workpiece 304. It may be suitable to utilize a particular pressure with the abrasive blasting media 302 to facilitate a suitable preparation of the surface of the workpiece 304. For example, the pressure of the carrier can be within a range between about 0.5 bars (5×10⁴ Pa) and about 8.0 bars (80×10⁴ Pa), and more particularly, within a range of about 0.5 bars (5×10⁴ Pa) and about 6.0 bars (60×10⁴ Pa).

Furthermore, the blasting machine 308 may utilize a recycling feature including a collection article 321 configured to gather the abrasive blasting media 302 that has been ejected from the nozzle 306 and used at least once to prepare the surface 305 of the workpiece 304. The collected abrasive blasting media 320 can be recycled through a sorting article 330, which may include one or more sieves. The sorting article 330 can remove fractured shaped abrasive particles or particles of a certain minimum size. Accordingly, a surviving grain factor for the abrasive blasting media 302 can be defined as the percentage of particles of the abrasive blasting media that survive a particular number of cycles (e.g., 20) through the sorting article.

As further illustrated according to FIG. 3, after the abrasive blasting media 302 exits the sorting article 330, the abrasive blasting media 302 can be placed in a hopper 310 configured to deliver the abrasive blasting media 302 to the blasting machine 308 for another cycle of the surface preparation operation.

In accordance with an embodiment, the process of preparing a surface of the workpiece can include changing an average surface roughness (Ra) of the workpiece. In at least one embodiment, the process of preparing can include increasing an average surface roughness of the workpiece by at least 1.0% from an initial average surface roughness according to the equation [(Ra−Rao)/Rao]×100%, wherein Ra represent the average surface roughness of the workpiece after conducting a surface preparation operation and Rao represents an initial average surface roughness of the workpiece prior to conducting the surface preparation operation. In other embodiments, the change in average surface roughness of the workpiece can be greater, such as at least about 2%, at least about 4%, at least about 6%, at least about 10%, at least about 20%, at least about 30%, or even at least about 35%. Still, the increase in average surface roughness may be not greater than about 95%, such as, not greater than about 90%, not greater than about 80%, or even not greater than about 70%. It will be appreciated that the increase in average surface roughness can be within range between any of the above minimum and maximum percentages.

Furthermore, the process of preparing a surface can include changing a maximum surface roughness (Rz) of the workpiece. In particular instances, the process of preparing the surface of the workpiece can include increasing the maximum surface roughness of the workpiece by at least 1% from an initial maximum surface roughness according to the equation [(Rz−Rzo)/Rzo]×100%, wherein Rz represents the maximum surface roughness of the workpiece after conducting the surface preparation operation and Rzo represents an initial maximum surface roughness of the workpiece prior to conducting the surface preparation operation. In other instances, the surface preparation operation may be conducted to increase the maximum surface roughness by at least about 2%, such as at least about 4%, at least about 6%, at least about 10%, at least about 20%, or even at least about 30%. Still, the increase in maximum surface roughness (Rz) due to the surface preparation operation may be not greater than about 95%, such as not greater than about 90%, not greater than about 80%, or even not greater than about 70%. It will be appreciated that the increase in maximum surface roughness during a surface preparation operation can be within a range between any of the minimum and maximum percentages noted above.

Furthermore, the batch of blasting media may be utilized in a surface preparation operation and be characterized by a particular surviving grain factor. As noted herein the surviving grain factor is a measure of the percentage of abrasive blasting media that survives a surface preparation operation conducted according to the embodiment of Example 1. In accordance with an embodiment, the surviving grain factor can be at least about 80% after conducting a surface preparation operation. In other instances, the surviving grain factor can be greater, such as at least about 82%, at least about 84%, at least about 86%, at least about 88%, or even at least about 90%. Still, the surviving grain factor may be not greater than about 99.5%. It will be appreciated that the surviving grain factor can be within a range between any of the minimum and maximum percentages noted above for a batch of abrasive blasting media used in surface preparation operation according to an embodiment herein.

The process of preparing a surface of the workpiece can include changing an average wetting angle according to a Sessile drop method or ASTM D7334-08. In particular instances, the process of preparing a surface can include increasing an average wetting angle relative to an initial wetting angle prior to the preparation process. In more particular instances, the process of preparing the surface can include increasing the average wetting angle relative to an initial wetting angle and further increasing the surface roughness of the surface of the workpiece.

In accordance with at least one embodiment, the process of preparing a surface of a workpiece can include conducting a surface preparation process such that the workpiece has an average wetting angle of greater than about 85 degrees. In certain instances, the process of preparing the surface of the workpiece can include increasing an average wetting angle of the workpiece surface, such that after the surface preparation process, the wetting angle is an obtuse angle. For example, after the surface preparation process, the average wetting angle of the workpiece may be greater than about 90 degrees, such as greater than about 91 degrees, greater than about 95 degrees, greater than about 100 degrees, or even greater than about 110 degrees. Still, the average wetting angle may be limited, such that it is not greater than about 170 degrees, or even not greater than about 160 degrees. It will be appreciated that after conducting a surface preparation process as noted herein, the average wetting angle of the workpiece can be within a range between any of the minimum and maximum values noted above.

Furthermore, after conducting a surface preparation operation, the wetting angle may change, and more particularly, increase by a certain percentage relative to the initial wetting angle. For example, in one embodiment the surface can demonstrate an increase in wetting angle of at least about 1% relative to initial wetting angle according to the equation [(Wa−Wi)/Wi]×100%, wherein Wa represents a wetting angle after conducting the surface preparation operation and Wi represents an initial wetting angle prior to conducting the surface preparation operation. In other instances, the increase in the wetting angle can be greater, such as at least about 2%, at least about 4%, at least about 6%, at least about 10%, at least about 20%, or even at least about 30%.

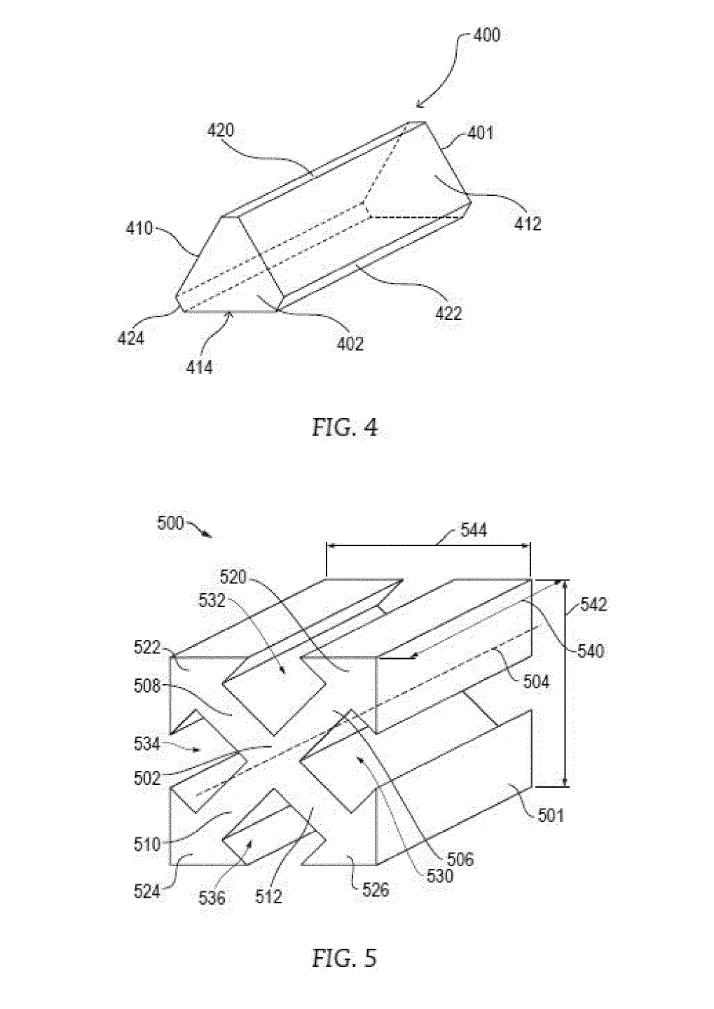

While certain aspects of embodiments herein have been directed to the shaped abrasive particle illustrated in FIGS. 1A and 1B, other shapes are contemplated. FIGS. 4-9 include exemplary abrasive blasting media shaped abrasive particles having specific contours and defining shaped abrasive particles, which can form the abrasive blasting media of embodiments herein. As shown in FIG. 4, the particle 400 may include a body 401 that is generally prismatic with a first end face 402 and a second end face 404. Further, the body 401 may include a first side face 410 extending between the first end face 402 and the second end face 404. A second side face 412 may extend between the first end face 402 and the second end face 404 adjacent to the first side face 410. As shown, the body 401 may also include a third side face 414 extending between the first end face 402 and the second end face 404 adjacent to the second side face 412 and the first side face 410.

As depicted in FIG. 4, the body 401 may also include a first edge 420 between the first side face 410 and the second side face 412. The body 401 may also include a second edge 422 between the second side face 412 and the third side face 414. Further, the body 401 may include a third edge 424 between the third side face 414 and the first side face 412.

As shown, each end face 402, 404 of the body 401 may be generally triangular in shape. Each side face 410, 412, 414 may be generally rectangular in shape. Further, the cross section of the body 401 in a plane parallel to the end faces 402, 404 can be generally triangular. It will be appreciated that while the cross-sectional shape of the body 401 through a plane parallel to the end faces 402, 404 is illustrated as being generally triangular, other shapes are possible, including any polygonal shapes, for example a quadrilateral, a pentagon, a hexagon, a heptagon, an octagon, a nonagon, a decagon, etc. Further, the cross-sectional shape of the shaped abrasive particle may be convex, non-convex, concave, or non-concave.

FIG. 5 includes an illustration of an abrasive blasting media shaped abrasive particle according to another embodiment. As depicted, the particle 500 may include a body 501 that may include a central portion 502 that extends along a longitudinal axis 504. A first radial arm 506 may extend outwardly from the central portion 502 along the length of the central portion 502. A second radial arm 508 may extend outwardly from the central portion 502 along the length of the central portion 502. A third radial arm 510 may extend outwardly from the central portion 502 along the length of the central portion 502. Moreover, a fourth radial arm 512 may extend outwardly from the central portion 502 along the length of the central portion 502. The radial arms 506, 508, 510, 512 may be equally spaced around the central portion 502 of the particle 500.

As shown in FIG. 5, the first radial arm 506 may include a generally arrow shaped distal end 520. The second radial arm 508 may include a generally arrow shaped distal end 522. The third radial arm 510 may include a generally arrow shaped distal end 524. Further, the fourth radial arm 512 may include a generally arrow shaped distal end 526.

FIG. 5 also indicates that the body 501 may be formed with a first void 530 between the first radial arm 506 and the second radial arm 508. A second void 532 may be formed between the second radial arm 508 and the third radial arm 510. A third void 534 may also be formed between the third radial arm 510 and the fourth radial arm 512. Additionally, a fourth void 536 may be formed between the fourth radial arm 512 and the first radial arm 506.

As shown in FIG. 5, the body 501 may include a length 540, a height 542, and a width 544. In a particular aspect, the length 540 is greater than the height 542 and the height 542 is greater than the width 544. In a particular aspect, the body 501 may define a primary aspect ratio that is the ratio of the length 540 to the height 542 (length:width). Further, the body 501 may define a secondary aspect ratio that is the ratio of the height 542 to the width 544 (width:height). Finally, the body 501 may define a tertiary aspect ratio that is the ratio of the length 540 to the width 542 (length:height).

According to one embodiment, the shaped abrasive particles can have a primary aspect ratio of at least about 1:1, such as at least about 1.1:1, at least about 1.5:1, at least about 2:1, at least about 2.5:1, at least about 3:1, at least about 3.5:1, at least 4:1, at least about 4.5:1, at least about 5:1, at least about 6:1, at least about 7:1, at least about 8:1, or even at least about 10:1.

In another instance, the shaped abrasive particle can be formed such that the body has a secondary aspect ratio of at least about 0.5:1, such as at least about 0.8:1, at least about 1:1, at least about 1.5:1, at least about 2:1, at least about 2.5:1, at least about 3:1, at least about 3.5:1, at least 4:1, at least about 4.5:1, at least about 5:1, at least about 6:1, at least about 7:1, at least about 8:1, or even at least about 10:1.

Furthermore, certain shaped abrasive particles can have a tertiary aspect ratio of at least about 1:1, such as at least about 1.5:1, at least about 2:1, at least about 2.5:1, at least about 3:1, at least about 3.5:1, at least 4:1, at least about 4.5:1, at least about 5:1, at least about 6:1, at least about 7:1, at least about 8:1, or even at least about 10:1.

Certain embodiments of the body 501 can have a shape with respect to the primary aspect ratio that is generally rectangular, e.g., flat or curved. The shape of the particle 500 with respect to the secondary aspect ratio may be any polyhedral shape, e.g., a triangle, a square, a rectangle, a pentagon, etc. The shape of the body 501 with respect to the secondary aspect ratio may also be the shape of any alphanumeric character, e.g., 1, 2, 3, etc., A, B, C. etc. Further, the contour of the body 501 with respect to the secondary aspect ratio may be a character selected from the Greek alphabet, the modern Latin alphabet, the ancient Latin alphabet, the Russian alphabet, any other alphabet, or any combination thereof. Further, the shape of the body 501 with respect to the secondary aspect ratio may be a Kanji character.

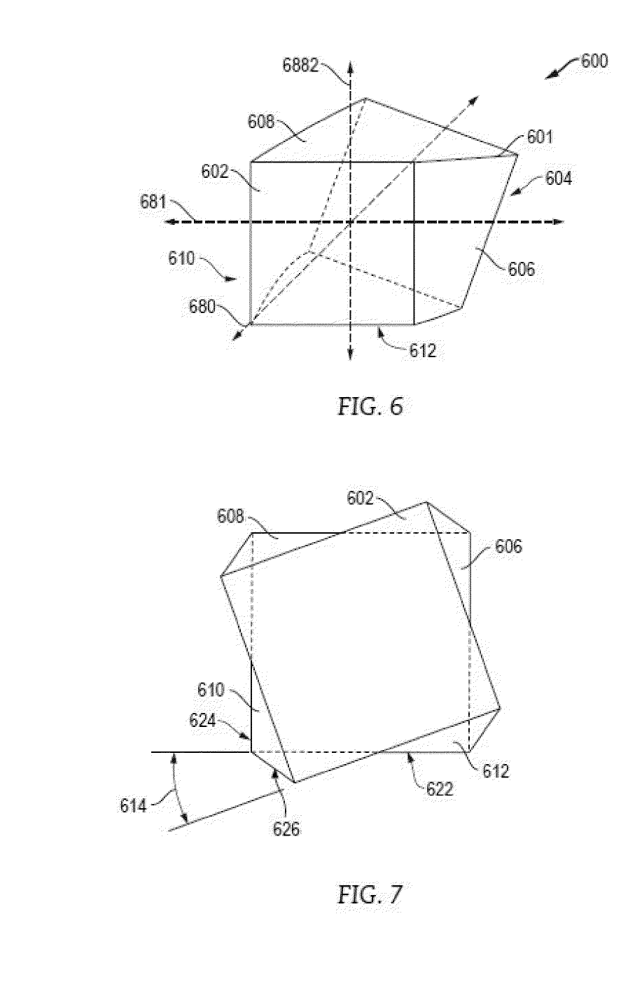

FIGS. 6-7 depict another embodiment of an abrasive blasting media shaped abrasive particle that is generally designated 600. As shown, the particle 600 may include a body 601 that has a generally cube-like shape. It will be appreciated that the shaped abrasive particle may be formed to have other polyhedral shapes. The body 601 may have a first end face 602 and a second end face 604, a first lateral face 606 extending between the first end face 602 and the second end face 604, a second lateral face 608 extending between the first end face 602 and the second end face 604. Further, the body 601 can have a third lateral face 610 extending between the first end face 602 and the second end face 604, and a fourth lateral face 612 extending between the first end face 602 and the second end face 604.

As shown, the first end face 602 and the second end face 604 can be parallel to each other and separated by the lateral faces 606, 608, 610, and 612, giving the body a cube-like structure. However, in a particular aspect, the first end face 602 can be rotated with respect to the second end face 604 to establish a twist angle 614. The twist of the body 601 can be along one or more axes and define particular types of twist angles. For example, as illustrated in a top-down view of the body in FIG. 7 looking down the longitudinal axis 680 defining a length of the body 601 on the end face 602 parallel to a plane defined by the lateral axis 681 extending along a dimension of width of the body 601 and the vertical axis 682 extending along a dimension of height of the body 601. According to one embodiment, the body 601 can have a longitudinal twist angle 614 defining a twist in the body 601 about the longitudinal axis such that the end faces 602 and 604 are rotated relative to each other. The twist angle 614, as illustrated in FIG. 7 can be measured as the angle between a tangent of a first edge 622 and a second edge 624, wherein the first edge 622 and second edge 624 are joined by and share a common edge 626 extending longitudinally between two of the lateral faces (610 and 612). It will be appreciated that other shaped abrasive particles can be formed to have twist angles relative to the lateral axis, the vertical axis, and a combination thereof. Any of such twist angles can have a value as described herein.

In a particular aspect, the twist angle 614 is at least about 1°. In other instances, the twist angle can be greater, such as at least about 2°, at least about 5°, at least about 8°, at least about 10°, at least about 12°, at least about 15°, at least about 18°, at least about 20°, at least about 25°, at least about 30°, at least about 40°, at least about 50°, at least about 60°, at least about 70°, at least about 80°, or even at least about 90°. Still, according to certain embodiments, the twist angle 614 can be not greater than about 360°, such as not greater than about 330°, such as not greater than about 300°, not greater than about 270°, not greater than about 230°, not greater than about 200°, or even not greater than about 180°. It will be appreciated that certain shaped abrasive particles can have a twist angle within a range between any of the minimum and maximum angles noted above.

Further, the body may include an opening that extends through the entire interior of the body along one of the longitudinal axis, lateral axis, or vertical axis.

FIG. 8 includes an illustration of another embodiment of an abrasive blasting media shaped abrasive particle. As shown, the particle 800 may include a body 801 having a generally pyramid shaped with a generally triangle shaped bottom face 802. The body can further include sides 816, 817, and 818 connected to each other and the bottom face 802. It will be appreciated that while the body 801 is illustrated as having a pyramidal polyhedral shape, other shapes are possible, as described herein.

According to one embodiment, the body 801 may be formed with a hole 804 (i.e., and opening) that can extend through at least a portion of the body 801, and more particularly may extend through an entire volume of the body 801. In a particular aspect, the hole 804 may define a central axis 806 that passes through a center of the hole 804. Further, the particle 800 may also define a central axis 808 that passes through a center 830 of the body 801. It may be appreciated that the hole 804 may be formed in the body 801 such that the central axis 806 of the hole 804 is spaced apart from the central axis 808 by a distance 810. As such, a center of mass of the body 801 may be moved below the geometric midpoint 830 of the body 801, wherein the geometric midpoint 830 can be defined by the intersection of a longitudinal axis 809, vertical axis 811, and the central axis (i.e., lateral axis) 808. Moving the center of mass below the geometric midpoint 830 of the shaped abrasive grain can increase the likelihood that the particle 800 lands on the same face, e.g., the bottom face 802, when dropped, or otherwise deposited, onto a backing, such that the body 801 has a predetermined, upright orientation.

In a particular embodiment, the center of mass is displaced from the geometric midpoint 830 by a distance that can be at least about 0.05 the height (h) along a vertical axis 810 of the body 802 defining a height. In another embodiment, the center of mass may be displaced from the geometric midpoint 830 by a distance of at least about 0.1(h), such as at least about 0.15(h), at least about 0.18(h), at least about 0.2(h), at least about 0.22(h), at least about 0.25(h), at least about 0.27(h), at least about 0.3(h), at least about 0.32(h), at least about 0.35(h), or even at least about 0.38(h). Still, the center of mass of the body 801 may be displaced a distance from the geometric midpoint 830 of no greater than 0.5(h), such as no greater than 0.49 (h), no greater than 0.48(h), no greater than 0.45(h), no greater than 0.43(h), no greater than 0.40(h), no greater than 0.39(h), or even no greater than 0.38(h). It will be appreciated that the displacement between the center of mass and the geometric midpoint can be within a range between any of the minimum and maximum values noted above.

In particular instances, the center of mass may be displaced from the geometric midpoint 830 such that the center of mass is closer to a base, e.g., the bottom face 802, of the body 801, than a top of the body 801 when the particle 800 is in an upright orientation as shown in FIG. 8.

In another embodiment, the center of mass may be displaced from the geometric midpoint 830 by a distance that is at least about 0.05 the width (w) along a lateral axis 808 of the of the body 801 defining the width. In another aspect, the center of mass may be displaced from the geometric midpoint 830 by a distance of at least about 0.1(w), such as at least about 0.15(w), at least about 0.18(w), at least about 0.2(w), at least about 0.22(w), at least about 0.25(w), at least about 0.27(w), at least about 0.3(w), or even at least about 0.35(w). Still, in one embodiment, the center of mass may be displaced a distance from the geometric midpoint 830 no greater than 0.5(w), such as no greater than 0.49 (w), no greater than 0.45(w), no greater than 0.43(w), no greater than 0.40(w), or even no greater than 0.38(w).

In another embodiment, the center of mass may be displaced from the geometric midpoint 830 along the longitudinal axis 809 by a distance (D1) of at least about 0.05 the length (l) of the body 801. According to a particular embodiment, the center of mass may be displaced from the geometric midpoint by a distance of at least about 0.1(l), such as at least about 0.15(l), at least about 0.18(l), at least about 0.2(l), at least about 0.25(l), at least about 0.3(l), at least about 0.35(l), or even at least about 0.38(l). Still, for certain abrasive particles, the center of mass can be displaced a distance no greater than about 0.5(l), such as no greater than about 0.45(l), or even no greater than about 0.40(l).

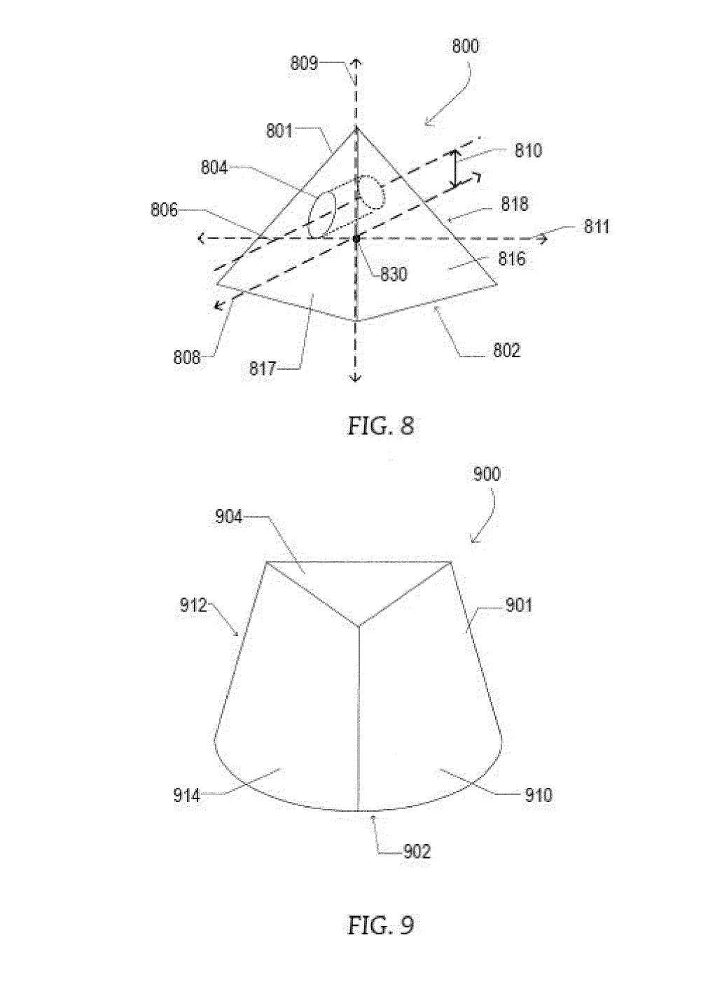

FIG. 9 includes an illustration of an abrasive blasting media shaped abrasive particle according to an embodiment. The particle 900 may include a body 901 including a base surface 902 and an upper surface 904 separated from each other by one or more side surfaces 910, 912, and 914. According to one particular embodiment, the body 901 can be formed such that the base surface 902 has a planar shape different than a planar shape of the upper surface 904, wherein the planar shape is viewed in the plane defined by the respective surface. For example, as illustrated in the embodiment of FIG. 9, the body 901 can have base surface 902 generally have a circular shape and an upper surface 904 having a generally triangular shape. It will be appreciated that other variations are feasible, including any combination of shapes at the base surface 902 and upper surface 904.

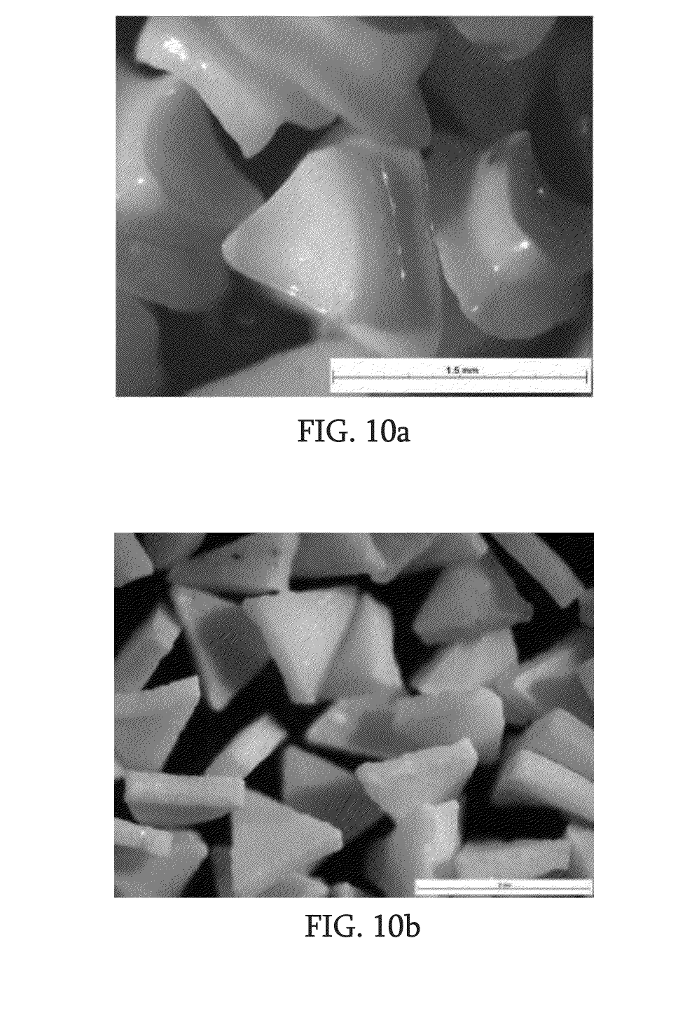

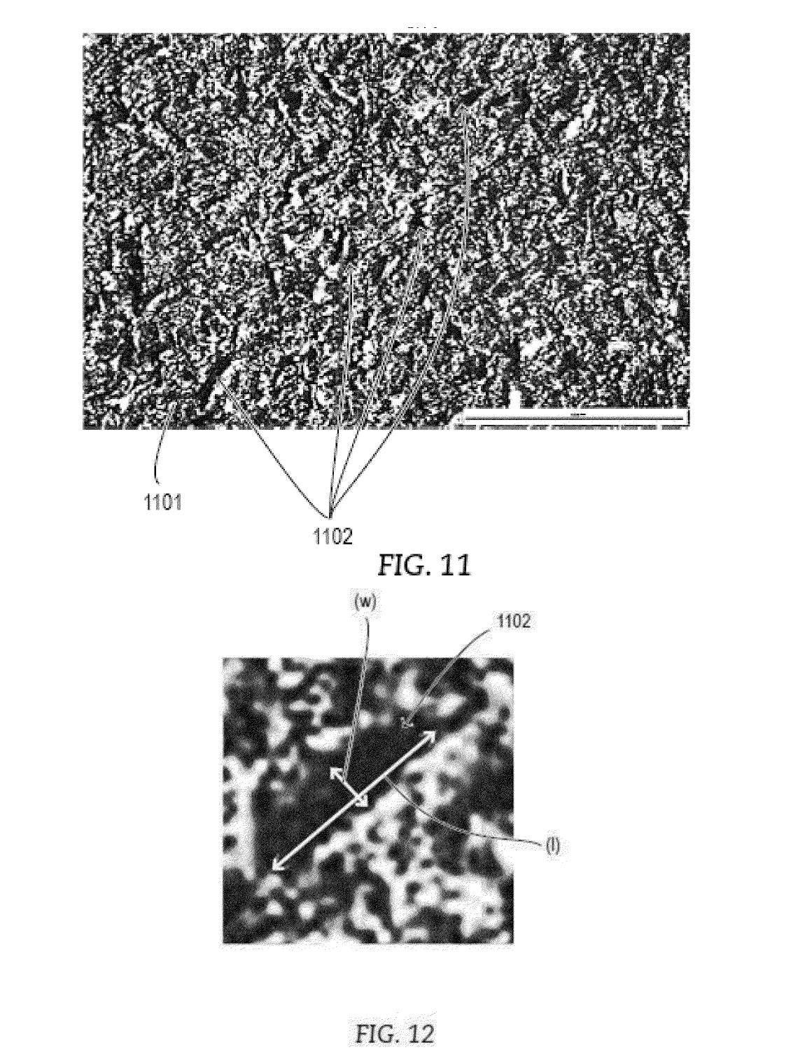

FIG. 10 includes a picture of a batch of abrasive blasting media including shaped abrasive particles. FIG. 11 includes an image of a portion of surface of a workpiece after conducting a surface preparation operation with the abrasive blasting media of FIG. 10. As shown, the workpiece can have a surface 1101 including gouges 1102 randomly distributed across a surface. Moreover, the gouges may have particular features, which may be related to certain aspects of the shaped abrasive particles utilized in the abrasive blasting media. In accordance with one embodiment, and as illustrated in FIG. 12, which includes a magnified view of one gouge of FIG. 11, the gouges can have an average length (l), an average width (w), which may define an aspect ratio of average length:average width of at least about 2:1. The length is the longest dimension of the gouge 1102 as viewed top-down in two dimensions and the width is the shortest dimension of the gouge 1102 extending in a direction perpendicular to the length as viewed top-down in two dimensions as illustrated in FIG. 12. In other embodiments, the aspect ratio of average length to average width can be greater, such as at least about 3:1, at least about 5:1, or at least about 10:1.

The gouges 1102 may have an average length (la) or not greater than about 5 mm, wherein the average length is based upon measurement of a random and statistically relevant sample size of gouges 1102 in a workpiece using suitable optical techniques. In other embodiments, the gouges 1102 may have an average length that is less, such as not greater than about 4 mm, or even not greater than 3 mm. Still, the gouges 1102 may have an average length that is at least about 0.2 mm or even at least about 0.5 mm. It will be appreciated that the gouges 1102 can have an average length within a range any of the minimum and maximum values noted above.

As further illustrated in FIG. 11, the gouges 1102 can have an average width that is not greater than about 1.0 mm, wherein the average width is based upon measurement of a random and statistically relevant sample size of gouges 1102 in a workpiece using suitable optical techniques. In other embodiments, the gouges 1102 may have an average width that is less, such as not greater than about 0.8 mm or even not greater than about 0.5 mm. Still, the gouges 1102 may be defined by a minimum width of at least about 0.01 mm, or even at least 0.05 mm. It will be appreciated that the gouges 1102 can have an average width within a range of between any of the minimum and maximum values noted above.

The gouges 1102 within the workpiece may further have an average depth, which may be a measure of the greatest distance the gouge 1102 extends from a point on the upper surface of the workpiece adjacent the gouge 1102 extending into the body of the workpiece in a direction perpendicular to the plane defined by the length and width. In accordance with an embodiment, the average depth can be less than the average length. Furthermore, the gouge 1102 may have an average depth less than the average width. In certain instances, the gouges 1102 may be characterized by a secondary aspect ratio (la:da), which can be a measure of average length to average depth, and may further have a value of at least about 2:1. In other embodiments, the secondary aspect ratio may be greater, such as at least about 3:1 or even at least about 5:1. Still, in at least one embodiment, the secondary aspect ratio may be not greater than about 100:1, not greater than about 10:1 or even not greater than about 8:1. It will be appreciated that the secondary aspect ratio of the gouges 1102 may be within a range between any of the above minimum and maximum ratios.

In certain instances, the gouges 1102 may be characterized by an average length that is related to at least one aspect of the shaped abrasive particles utilized in the abrasive blasting media. For example, a majority of the gouges 1102 present on the surface can have an average length that is no greater than an average width of the plurality of shaped abrasive particles. In particular instances, it may be evident that the gouges 1102 can correspond to certain dimensions of the shaped abrasive particles. For example the gouges may correspond to cuts made by the edges of the plurality of shaped abrasive particles along the side of the particle defining the width.

In certain aspects, the shaped abrasive particles may be formed according to an alternative method, including for example, but not limited to a process of extruding a “stiff” mixture or gel into an opening of a shaping assembly and using a particular method of removing the mixture from the opening via an ejection material. Moreover, such forming processes and control of the manner of ejection can facilitate the formation of certain features of the shaped abrasive particles.

For example, in one embodiment, a shaped abrasive particle can include a body having a tortuous contour, which may be facilitated by particular aspects of the alternative forming process. In particular instances, the tortuous contour can include a first curved portion, a second curved portion, and a planar portion joining the first curved portion and the second curved portion. FIG. 20 includes a side view (inverted color) image of a shaped abrasive particle made according to an embodiment herein. The shaped abrasive particle 2000 can include a body 2001 having a first major surface 2003, a second major surface 2004, and a side surface 2005 extending between and separating the first major surface 2003 and the second major surface 2004. In particular, and in accordance with an embodiment, the first major surface 2003 can have a tortuous contour, which may include a first curved portion 2006, a second curved portion 2008, and a substantially planar or linear region 2007 connecting and extending between the first curved portion 2006 and the second curved portion 2008. In one particular embodiment, the first curved portion 2006 may define a substantially arcuate curvature, which may include a substantially convex curvature. The second curved portion 2008 can be spaced apart from the first curved portion 2006 and define a substantially arcuate curvature, and particularly, a substantially concave portion.

In certain embodiments, such as illustrated in FIG. 20 the first curved portion 2006 can define a first radius of curvature and the second curved portion 2008 can define a second radius of curvature according to a portion of the curve best fit to a circle. Such analysis may be completed using imaging software, such as ImageJ. In one embodiment, the first curved portion 2006 and the second curved portion 2008 can have different radiuses of curvatures compared to each other. In still another embodiment, the radius of curvatures associated with the first curved portion 2006 and second curved portion 2008 may be substantially similar. Moreover, in another particular embodiment, it has been observed that the tortuous contour of the first major surface 2003 can include a first curved portion 2006 having a radius of curvature that is greater than an average height of the body 2001, wherein the height can be measured as the average distance between the first major surface 2003 and second major surface 2004. Additionally, in another embodiment, it has been observed that the tortuous contour of the first major surface 2004 can include a second curved portion 2008 having a radius of curvature that is greater than the average height of the body 2001.

In accordance with one particular embodiment, the tortuous contour can include a particular waviness. The waviness can be defined as a portion of any surface having the tortuous contour including a first curved portion extending above a line and further comprising a second curved portion extending below the line. Referring again to FIG. 20, a line 2010 is drawn between the corners of the first major surface 2003 and the side surface 2005 of the body 2001. In some instances, the line 2010 may be parallel to the opposing major surface if the opposite major surface defines a substantially planar surface, such as the second major surface 2004 of the body 2001 shown in FIG. 20. As illustrated, the first major surface can have a tortuous contour including a waviness, wherein the first curved portion 2006 includes a region of the first major surface 2003 that extends on one side (i.e., below in the orientation illustrated) and the second curved portion 2008 includes a region of the first major surface 2003 that extends on the opposite side (i.e., above in the orientation illustrated) of the line 2010 relative to the region of the first major portion 2006.

In a particular embodiment, the curved portions can define a peak height or valley height depending on the relationship of the curved portions 2006 and 2008 relative to the line 2010. The peak height can be the greatest distance between a point within the curved portion and the line 2010. For example, the second curved portion 2008 can have a peak height 2020 as the greatest distance between a point on the first major surface 2002 within the second curved portion 2008 and the line 2010, in a direction perpendicular to the line and generally extending in the direction of the height of the particle as viewed from the side. According to one embodiment, the peak height 2020 can be at least about 5% of an average height of the body 2001. In other instances, it can be greater, such as at least about 10%, at least about 15%, at least about 20%, at least about 25%, at least about 30%, at least about 35%, at least about 40%, or even at least about 50%. In still another non-limiting embodiment, the peak height 2020 can be less than about 150%, such as less than about 90% of the average height of the particle. It will be appreciated that the peak height can be within a range between any of the above minimum and maximum percentages.

Moreover, while not illustrated, the first curved portion 2006 can define a valley height, as the maximum distance between the line 2010 and a portion of the first major surface 2003 within the first curved portion 2006. The valley height can have the same features as the peak height 2020 associated with the second curved portion 2008.

In another embodiment, the tortuous contour can be defined by a portion of the body wherein a slope of a trace line extending along the tortuous contour changes slope from a region defining a positive slope of the trace line, to a slope of zero, to a negative slope. For example, referring to FIG. 20, a trace line 2012 can be formed along the tortuous surface and define a first region 2013 having a positive slope, a region 2014 including a slope of zero, and a region wherein the slope of the trace line 2012 changes to a negative value. It will be appreciated that a tortuous surface can include additional changes in slope, including for example, an additional transition to a region having a slope of zero, and a transition to a region having a positive or negative slope. Such characteristics may be defined generally as a sinusoidal-like curve, which is not to be interpreted as requiring the trace line 2012 to comply with the exact mathematical formula of a sine wave function, but rather as a description of the approximate change in curvature of the trace line 2012.

Notably, as illustrated in the embodiment of FIG. 20, the tortuous contour can extend along a first major surface 2003 of the body 2001, and may raise at least a portion of the first major surface 2003 above the edge of the side surface even in a side view. However, it will be appreciated that in other embodiments, the tortuous contour may extend along other surfaces of the body 2001, including, but not limited to, the second major surface 2004 and the side surface 2005. Moreover, it will be appreciated that more than one surface of the body 2001 of a shaped abrasive particle according to embodiments herein can exhibit a tortuous contour.

The tortuous contour can extend along at least a portion of any surface of the body 2001. In particular instances, the tortuous contour can extend along a majority of at least one surface (e.g., the first major surface 2003, second major surface 2004, or side surface 2005) of the body 2001. In more particular instances, the tortuous contour can define at least about 60%, such as at least about 70%, at least about 80%, at least about 90%, or even essentially all of at least one surface of the body 2001.

Moreover, other surfaces not exhibiting a tortuous surface may have other features, including other features of the embodiments herein (e.g., a fractured surface, an arrowhead shape, etc.) or even a substantially planar contour. For example, any one of the surfaces of the body 2001 including but not limited to, the first major surface 2003, second major surface 2004, and side surface 2005, not having a tortuous surface, may exhibit a substantially planar surface. Still, it will be appreciated that surfaces exhibiting a tortuous surface may have additional features, including other features of the embodiments herein, including for example, a fractured surface, an arrowhead shape, and the like.

In accordance with another aspect, the body 2001 can have a first corner 2031 comprising a first height, measured as the distance between the first major surface 2003 and the second major surface 2004 along the side surface 2005, and more particularly, the distance between the corner 2031 and the corner 2031 in a direction of the height perpendicular to the line 2010. The body 2001 can have a second height at the second corner 2035, measured as the distance between the first major surface 2003 and the second major surface 2004 along the side surface 2005, and more particularly, the distance between the corner 2035 and the corner 2034 in a direction of the height perpendicular to the line 2010. In particular, the first height can be significantly different than the second height. In certain embodiments, the first height can be significantly less than the second height. FIG. 22 includes a side view of a batch of such shaped abrasive particles as further illustration of such features. Notably, the tortuosity of the particles is evident.

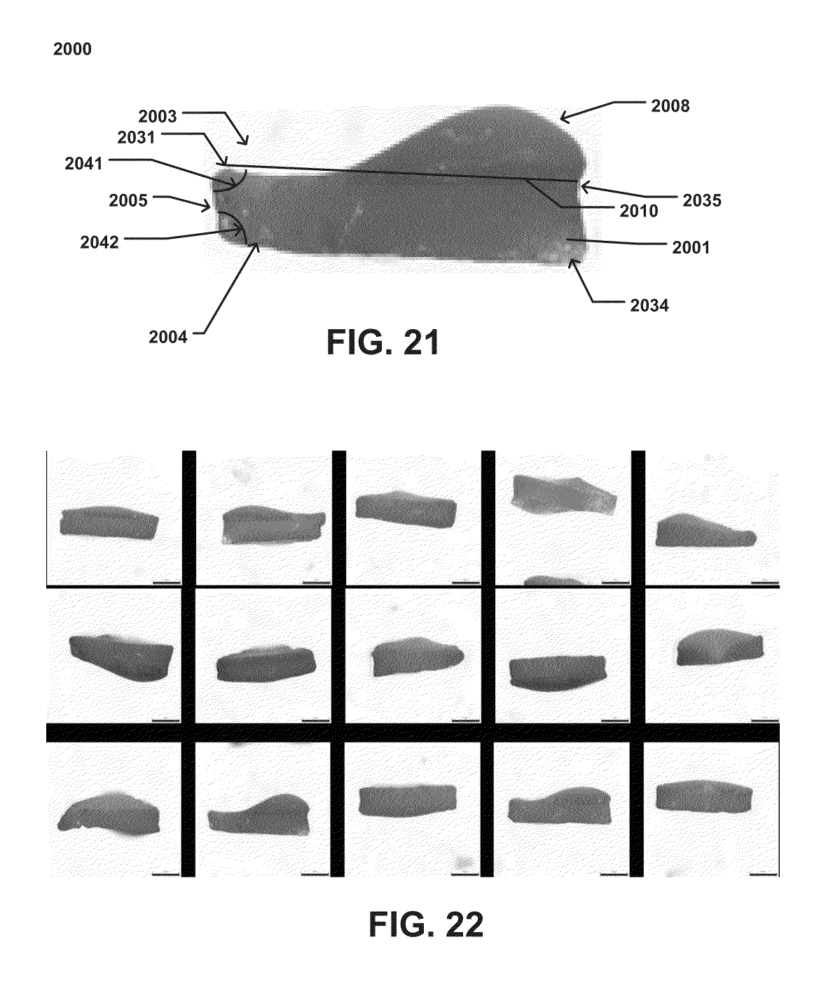

In accordance with an embodiment, the body 2001 of the shaped abrasive particle 2000 can include a first upper angle 2041 between the first major surface 2003 and the side surface 2005 as viewed from the side as illustrated in FIG. 21. The first upper angle 2041 can be at least about 80 degrees, such as at least about 85 degrees. In other embodiments, the first upper angle can be not greater than about 110 degrees. In at least one embodiment, the side surface 2005 can extend at a generally orthogonal angle relative to at least one of the first major surface 2003 and the second major surface 2004. More particularly, the side surface 2005 can extend at a generally orthogonal angle relative to the first major surface 2003 and the second major surface 2004.

The body 2001 of the shaped abrasive particle 2000 can include a second lower angle 2042 between the second major surface 2003 and the side surface 2005 as viewed from the side as illustrated in FIG. 21. The second lower angle 2042 can be at least about 80 degrees, such as at least about 85 degrees. In other embodiments, the second lower angle 2042 can be not greater than about 110 degrees.

According to one embodiment, the percent flashing (f) of the body 2001 can be at not greater about 10%, such as at not greater than about 9%, not greater than about 8%, not greater than about 7%, not greater than about 6%, not greater than about 5%, or even not greater than about 4%. Still, in one non-limiting embodiment, the percent flashing can be at least about 0.1%.

It will be appreciated that any of the characteristics of the embodiments herein can be attributed to a batch of blasting media. A batch of can include, but need not necessarily include, a group of abrasive particles, such as shaped abrasive particles, made through the same forming process. In yet another instance, a batch of blasting media can be a group of shaped abrasive particles of an abrasive article, such as a fixed abrasive article, and more particularly, a coated abrasive article, which may be independent of a particular forming method, but having one or more defining features present in a particular population of the particles. For example, a batch may include an amount of shaped abrasive particles suitable for use in commercial blasting processes, such as at least about 20 lbs.

Moreover, any of the features of the embodiments herein (e.g., aspect ratio, planar portions, tortuous contour, etc.) can be a characteristic of a single particle, a median value from a sampling of particles of a batch, or an average value derived from analysis of a sampling of particles from a batch. Unless stated explicitly, reference herein to the characteristics can be considered reference to a median value that is a based on a statistically significant value derived from a random sampling of suitable number of particles of a batch. Notably, for certain embodiments herein, the sample size can include at least 10, such as at least about 15, and more typically, at least 40 randomly selected particles from a batch.

Any of the features described in the embodiments herein can represent features that are present in at least a first portion of a batch of blasting media. Moreover, according to an embodiment, control of one or more process parameters can control the prevalence of one or more features of the shaped abrasive particles of the embodiments herein.

The first portion may be a minority portion (e.g., less than 50% and any whole number integer between 1% and 49%) of the total number of particles in a batch, a majority portion (e.g., 50% or greater and any whole number integer between 50% and 99%) of the total number of particles of the batch, or even essentially all of the particles of a batch (e.g., between 99% and 100%). The provision of one or more features of any shaped abrasive particle of a batch may facilitate alternative or improved performance of the blasting media.

A batch of particulate material can include a first portion including a first type of shaped abrasive particle and a second portion including a second type of shaped abrasive particle. The content of the first portion and second portion within the batch may be controlled. Provision of a batch having a first portion and a second portion may facilitate alternative or improved performance.

### Example 1

Five samples of abrasive blasting media are evaluated according to a standardized surface preparation operation. Sample S1 represents a batch of abrasive blasting media according to an embodiment, wherein the batch consists essentially of shaped abrasive particles illustrated in FIG. 10a. The shaped abrasive particles are screen printed particles, having a generally triangular two-dimensional shape, comprising alpha alumina, and having an average width of greater than 850 microns, an interior height (hi) of approximately 440 microns, and a middle length (L middle) of approximately 1.38 mm.

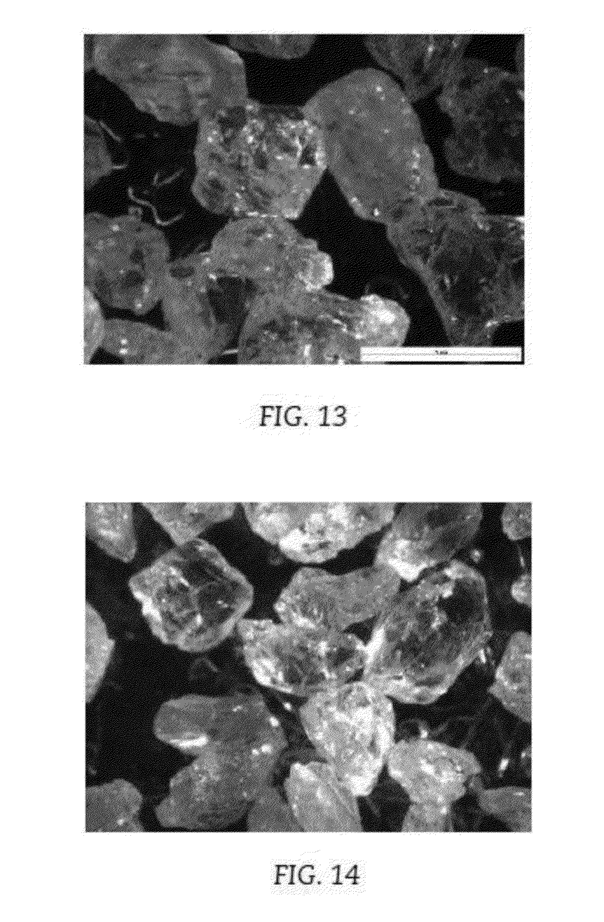

Sample CS2 is a conventional, crushed and randomly shaped abrasive particle of alpha alumina having an average particle size of approximately 710 microns to 850 microns, commercially available as 38A Alundum from Saint-Gobain Corporation. A picture of a portion of the particles of Sample CS2 is provided in FIG. 13.

Sample CS3 is a conventional, crushed and randomly shaped abrasive particle of alpha alumina having an average particle size of approximately 500 microns to 600 microns, commercially available as 38A Alundum from Saint-Gobain Corporation. A picture of a portion of the particles of Sample CS3 is provided in FIG. 14.

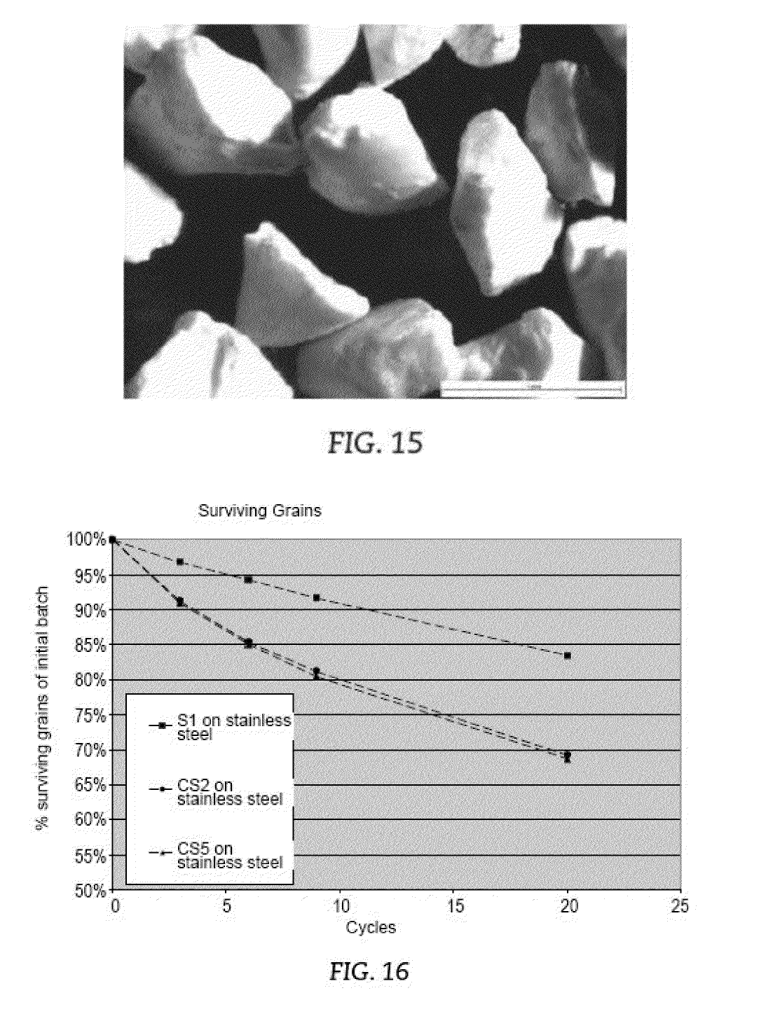

Sample CS4 is a conventional, crushed and randomly shaped abrasive particle of fused zirconia and silica having an average particle size of approximately 600 microns to 850 microns, commercially available as Zirgrit T20 from Saint-Gobain ZirPro. A picture of a portion of the particles of Sample CS4 is provided in FIG. 15.

Sample CS5 is a conventional, crushed and randomly shaped abrasive particle of alpha alumina having an average particle size of greater than 850 microns commercially available as 38A Alundum from Saint-Gobain Corporation.

Sample S2 is a batch of abrasive blasting media, wherein the batch consists essentially of shaped abrasive particles, as illustrated in FIG. 10b. The shaped abrasive particles are extruded particles, having a generally triangular two-dimensional shape, comprising alpha alumina, and having an average width of greater than 850 microns and essentially no flashing. The particles were essentially flat but may have exhibited some slight dishing, generally within a range between about 1.10 to 1.15. Moreover, the particles exhibited some tortuosity as disclosed in the embodiments herein.

Certain samples were tested according to the surface preparation operation test as detailed herein to determine the surviving grain factor, which is determined after 20 cycles on a workpiece comprising stainless steel. The workpiece was 304L stainless steel (AISI designation) having approximately 0.03% carbon, 2% manganese, 1% silicon, 18% chromium, 10% nickel and the remainder of iron. Notably, the weight of the batch was measured after cycles, 3, 6, 9, and 20 to obtain a plot, which is provided in FIG. 16. The surviving grain factor was calculated based on the initial average particle size of each sample. The surviving grain factor of Sample S1 was based on particles having an average particle size of greater than 600 microns, Sample CS2 was based on particles having an average particle size greater than 500 microns, and Sample CS5 was based on particles having an average particle size greater than 600 microns. As illustrated in FIG. 16, the surviving grain factor of Sample S1 was significantly better as compared to Samples CS2 and CS5.

Furthermore, Table 1 below provides further details of results of the surface preparation operation for Samples S1, S2, CS2, CS4, and CS5 of Example 1. As indicated in Table 1, Sample S1 demonstrated a significantly smaller percentage of fractured grains after completing the surface preparation operation compared to all other sample. Moreover, as further illustrated in the data of Table 1, after completing the surface preparation operation, the surface roughness of the workpiece was greater with Sample S1 as compared to the surface roughness of the workpiece using any of the other samples. Also interesting is the fact that while Samples S2 demonstrated approximately the same surface roughness as compared to the samples CS2, CS4, and CS5, the % of fines less than 150 microns was significantly lower than all other samples, which may make the material desirable to certain users concerned about production of fines in the blasting environment. Moreover, the percentage of surviving grains for Sample S2 was superior compared to the comparative samples.

TABLE 1

| | % of | % Fines less | Surface |
|---|---|---|---|
| Results after | surviving | than 150 | roughness |
| 20 passes | grains | microns | Ra (μm) |
| Sample S1 | 83.4% | 17.3% | 5.7 |
| Sample CS2 | 69.2% | 16.3% | 4.5 |
| Sample CS4 | 69.8% | 13.2% | 4.3 |
| Sample CS5 | 68.7% | 12.4% | 4.5 |
| Sample S2 | 78% | 9.8% | 4.5 |

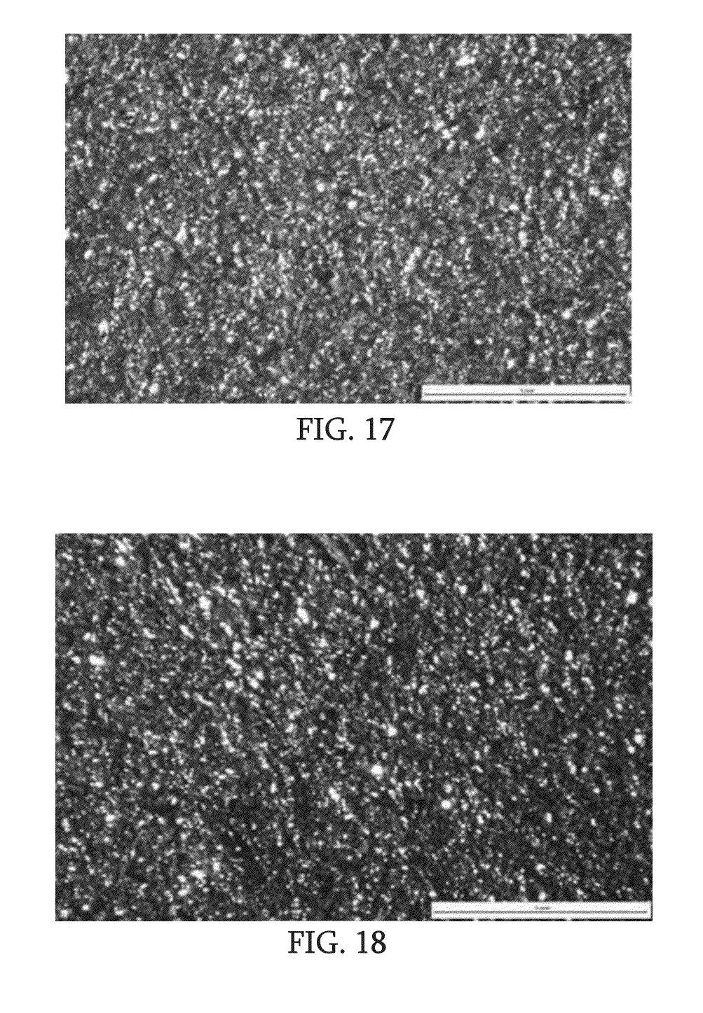

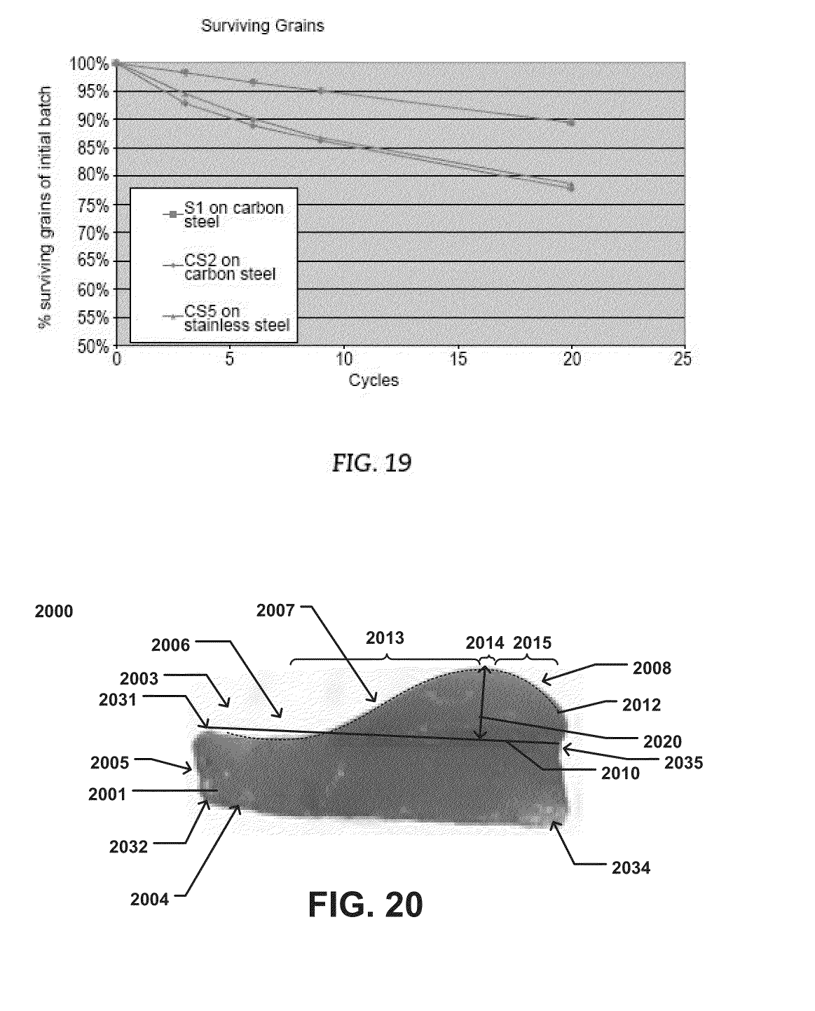

As further evidence of the difference in the surface of the workpiece, FIGS. 17 and 18 provide images of the surface of the workpiece after conducting the surface preparation operation with Samples CS2 and CS4 respectively. FIG. 11 is representative of the surface of the workpiece after conducting the surface preparation operation with Sample S1. The surfaces of the workpieces illustrated in FIGS. 17 and 18 look relatively the same compared to each other. Notably, the surfaces of the workpieces in FIGS. 17 and 19 do not demonstrate gouges, which are clearly shown in FIG. 11.

### Example 2

Certain samples (S1, CS2, CS4, CS5, and S2) were tested according to a surface preparation operation as detailed herein. The workpiece was low carbon steel, having a 1008 or 1010 AISI designation, and a general composition of 0.12% carbon, 0.6% manganese, 0.4% silicon, 0.05% sulfur, 0.04% phosphorus, and a remainder of iron. Notably, the weight of each sample batch was measured after cycles, 3, 6, 9, and 20 to obtain a plot, which is provided in provided in FIG. 19. Based on the initial average particle size of each sample, the surviving grain factor of Sample S1 was based on particles having an average particle size of greater than 600 microns, Sample CS2 was based on particles having an average particle size greater than 500 microns, and Sample CS5 was based on particles having an average particle size greater than 600 microns. As illustrated in FIG. 16, the surviving grain factor of Sample S1 was significantly better as compared to Samples CS2 and CS5.

Table 2 below provides further details of results of the surface preparation operation for Samples S1, CS2, CS4, CS5, and S2 of Example 2. As indicated in Table 2, Samples S1 and S2 demonstrated a significantly smaller percentage of fractured grains after completing the surface preparation operation as compared to samples CS2, CS4, and CS5, thus indicating a blasting media capable of extending the term of blasting operations before fracturing. Moreover, as further illustrated in the data of Table 2, after completing the surface preparation operation, the surface roughness of the workpiece was greater with Sample S1 as compared to the surface roughness of the workpiece using any of the other samples. Still, Sample S2 demonstrated the lowest percentage of fines less than 150 microns for all of the samples, which may be particularly suitable for certain applications desiring to reduce the content of fine particles.

TABLE 2

| | % of | % Fines less | Surface |
|---|---|---|---|
| Results after | surviving | than 150 | roughness |
| 20 passes | grains | microns | Ra (μm) |
| Sample S1 | 89.3% | 20.9% | 6.5 |
| Sample CS2 | 77.7% | 18.8% | 5.3 |
| Sample CS4 | 78.3% | 16.1% | 4.1 |
| Sample CS5 | 78.5% | 14.5% | 5.3 |
| Sample S2 | 85.4 | 10.9% | 5.4 |

### Example 3

After conducting the surface preparation operations of Example 1 and Example 2, the average wetting angle of each of the workpieces was calculated according to ASTM D7334-08 for certain samples. In particular, the average wetting angle values were derived from 10 measurements taken at random locations on the surface of the workpiece. Tables 3 and 4 provide results of wetting angle and percent change of wetting angle for the samples conducted on stainless steel (Example 1) and low carbon steel (Example 2), respectively. The average wetting angle for the untreated sample of stainless steel, which was not subject to a surface preparation operation with any of the samples, was 18 degrees. The average wetting angle for the untreated sample of low carbon steel workpiece, which was not subject to a surface preparation operation with any of the samples, was 27 degrees. The percent change versus initial wetting angle was calculated using [(Wat−Wai)/Wai]×100%, wherein Wat is the average wetting angle after treatment with a sample of abrasive blasting media and Wai represents the initial wetting angle of the workpiece material prior to conducting a surface preparation operation with a sample.

Sample S1 demonstrated surprising results as compared to the results of Samples CS2, CS3, and CS4. In particular, Sample S1 demonstrated the ability to create significantly increased surface roughness relative to an initial value, however, the samples also demonstrated a decrease in wettability (i.e., increase in wetting angle). Generally, as surface roughness increases one expects wettability to increase. Accordingly, while it is not entirely understood, the abrasive blasting media of Sample S1 modified the surface of the workpiece to have an unexpected combination of characteristics. Furthermore, as demonstrated in Tables 3 and 4, the percent change in initial wetting angle for Sample S1 is significantly greater than all of the comparative examples, and in some instances, approximately a 25% difference.

TABLE 3

| Angle (°) | S1 | CS2 | CS3 | CS4 |
|---|---|---|---|---|
| Average | 92 | 77 | 76 | 82 |
| % change vs initial wetting angle | 415% | 330% | 329% | 360% |

TABLE 4

| Angle (°) | S1 | CS2 | CS3 | CS4 |
|---|---|---|---|---|
| Average | 119 | 89 | 91 | 104 |
| % change vs initial wetting angle | 304% | 204% | 210% | 253% |

### Example 4

The same test of Example 3 was conducted for Example 4 with Samples S1, S2, and CS2 on a different workpiece of stainless steel compared to the samples of Example 3. The results of the test are provided below in Table 5. Notably, while the absolute values of wetting angle differ compared to the results of Example 3 for samples S1 and CS2, the trends are the same and remarkable.

TABLE 5

| Angle (°) | S1 | S2 | CS2 |
|---|---|---|---|
| Average | 96 | 116 | 56 |
| % change vs initial wetting angle | 1% | 23% | −41% |

The same test of Example 3 was conducted for Example 4 with Samples S2 and CS2 on different workpiece of low carbon steel as compared to the samples of Example 3. The results of the test are provided below in Table 6. Notably, while the absolute values of wetting angle differ compared to the results of Example 3 for samples S1 and CS2, the trends are the same and remarkable.

TABLE 6

| Angle (°) | S2 | CS2 |
|---|---|---|
| Average | 114 | 64 |
| % change vs initial wetting angle | 18% | −33% |

The present application represents a departure from the state of the art. The industry has tended to utilized crushed grains having a rounded or irregular orientation for abrasive blasting media. However, it has been discovered that the utilization of abrasive blasting media including shaped abrasive particles can facilitate formation of a combination of unique surface features on a workpiece. Moreover, it is noted that the abrasive blasting media including shaped abrasive particles can have a unique properties, such as, surviving grain factor. Additionally, the shaped abrasive particles of the abrasive blasting media can have a combination of unique features, including but not limited to composition, additives, morphology, two-dimensional shape, three-dimensional shape, distribution of phases, difference in height, difference in height profile, flashing percentage, height, dishing, and the like. And in fact, particulate material of embodiments herein, have proven to result in remarkable and unexpected performance.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. Abrasive blasting media comprising a shaped abrasive particle.

2. The abrasive blasting media of claim 1, wherein the shaped abrasive particle comprises a body including a length (l), a width (w), and a height (hi), wherein the height (hi) is an interior height of the body, and wherein w≧l and w≧hi.

3. The abrasive blasting media of claim 2, wherein the body comprises a two-dimensional polygonal shape as viewed in a plane defined by a length and width.

4. The abrasive blasting media of claim 2, wherein the body comprises abrasive grains selected from the group of materials consisting of nitrides, oxides, carbides, borides, oxynitrides, diamond, and a combination thereof.

5. The abrasive blasting media of claim 2, wherein the interior height is at least about 22% of the width.

6. The abrasive blasting media of claim 2, wherein the body comprises a percent flashing (f) of at least about 10% for a total side area of the body.

7. The abrasive blasting media of claim 2, wherein the body comprises a percent flashing (f) of not greater than about 45% for a total side area of the body.

8. The abrasive blasting media of claim 2, wherein the body comprises a dish-shaped particle, wherein the body comprises a dishing value (d) of not greater than about 2.

9. The abrasive blasting media of claim 2, wherein the body comprises a dishing value (d) of at least about 0.1.

10. The abrasive blasting media of claim 2, wherein the body comprises a profile ratio of at least about 0.04, wherein the profile ratio is defined as a ratio between an average difference in height and a profile length [(hc−hm)/(Lmiddle)] wherein the profile ratio is not greater than about 0.3.

11. The abrasive blasting media of claim 2, wherein the first side surface and second side surface are tapered relative to a vertical axis extending in a direction of a height of the body.

12. The abrasive blasting media of claim 1, further comprising a surviving grain factor of at least about 80%.

13. A method of preparing a surface of a workpiece comprising:
directing an abrasive matter at a workpiece, the abrasive matter comprising a carrier and a plurality of shaped abrasive particles;
increasing an average surface roughness (Ra) of a surface of the workpiece from an initial average surface roughness; and
increasing an average wetting angle relative to an initial average wetting angle.

14. The method of claim 13, wherein the carrier comprises a gaseous material.

15. The method of claim 13, further comprising gathering a plurality of shaped abrasive particles as a batch of free abrasives, further comprising sorting the plurality of shaped abrasive particles, and wherein directing comprises projecting each of the shaped abrasive particles of the plurality of shaped abrasive particles as a free abrasive particles in a stream with the carrier.

16. The method of claim 13, wherein increasing the average surface roughness comprises increasing an average surface roughness (Ra) of the workpiece by at least 1% from an initial average surface roughness according to the equation [(Ra−Rao)/Rao]×100%, wherein Ra represents the average surface roughness of the workpiece after conducting a surface treatment operation and Rao represents an initial average surface roughness of the workpiece prior to conducting the surface treatment operation.

17. The method of claim 13, further comprising recovering at least a portion of the plurality of the shaped abrasive particles after preparing, wherein a surviving grain factor is at least about 80% after conducting a surface treatment operation.

18. The method of claim 13, wherein increasing the average wetting angle comprises increasing the average wetting angle by at least about 1% relative to an average initial wetting angle according to the equation [(Wa−Wi)/Wi]×100%, wherein Wa represents the average wetting angle after conducting a surface treatment operation and Wi represents an initial average wetting angle prior to conducting a surface treatment operation.

19. The method of claim 13, wherein the body comprises a shape selected from the group consisting of triangular, quadrilateral, rectangular, trapezoidal, pentagonal, hexagonal, heptagonal, hexagonal, octagonal, nonagonal, decagonal, pentagon, and a combination thereof.

20. A workpiece having a surface modified by abrasive blasting media comprising gouges randomly distributed across the surface, wherein the gouges have an average length and an average width, and further define an aspect ratio of average length:average width of at least about 2:1.
